(19) United States
(12) Patent Application Publication
(10) Pub. No.: US 2005/0054439 A1
(43) Pub. Date: Mar. 10, 2005

(54) Wide area gaming and retail player tracking

(75) Inventors: Richard E. Rowe, Incline Village, NV (US); Joseph E. Kaminkow, Reno, NV (US)

Correspondence Address: BEYER WEAVER & THOMAS LLP, P.O. BOX 70250, OAKLAND, CA, 94612-0250, US

(73) Assignee: IGT, Reno, NV (US)

(21) Appl. No.: 10/914,944

(22) Filed: Aug. 9, 2004

Related U.S. Application Data
(63) Continuation-in-part of application No. 09/927,742, filed on Aug. 10, 2001, now abandoned.

(51) Int. Cl. A63F 13/00

(52) U.S. Cl. 463/29

(57) ABSTRACT

Systems and methods for tracking, differentiating and awarding loyalty credits to patrons of a gaming establishment are disclosed. Tracking can be facilitated by and loyalty credits can be stored on patron issued loyalty credit instruments such as printed tickets, magnetic-striped cards, room keys, portable wireless devices and smart cards. Loyalty credits can be awarded for and combined with other loyalty credits awarded for gaming activities involving wagers, game play, and possible monetary awards, as well as purchasing activities involving the procurement of food, lodging, entertainment, transportation, merchandise or services. Theoretical all expenditures profiles can be established for patrons based upon the gaming activities and purchasing activities of the patrons. Customized comps can be awarded on the initiative of the gaming establishment and without any specific request from a patron. Such comps can be based on tracked information on gaming activities and purchasing activities of the patrons.

### CROSS-REFERENCE TO RELATED APPLICATIONS

The present application is a continuation-in-part of co-pending and commonly owned U.S. patent application Ser. No. 09/927,742 by Kaminkow filed Aug. 10, 2001, and entitled “Flexible Loyalty Points Programs,” which is incorporated by reference herein in its entirety and for all purposes.

### TECHNICAL FIELD

The present invention relates generally to casino gaming and related retail services, and more specifically to systems and methods for tracking customer activities and providing loyalty programs therefor.

### BACKGROUND

As technology in the gaming industry progresses, traditional mechanically driven reel slot machines are being replaced or supplemented with electronic counterparts having CRT, LCD video displays or the like and gaming machines such as video slot machines and video poker machines are becoming increasingly popular. Part of the reason for their increased popularity is the nearly endless variety of games that can be implemented on gaming machines utilizing advanced electronic technology. In some cases, newer gaming machines are utilizing computing architectures developed for personal computers. These video/electronic gaming advancements enable the operation of more complex games, which would not otherwise be possible on mechanical-driven gaming machines and allow the capabilities of the gaming machine to evolve with advances in the personal computing industry.

Typically, utilizing a master gaming controller, the gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including touch screens and button pads, to determine the wager amount and initiate game play.

After game play has been initiated, the gaming machine determines a game outcome, presents the game outcome to the player and may dispense an award of some type depending on the outcome of the game. A game outcome presentation may utilize many different visual and audio components such as flashing lights, music, sounds and graphics. The visual and audio components of the game outcome presentation may be used to draw a player's attention to various game features and to heighten the player's interest in additional game play. Maintaining a game player's interest in game play, such as on a gaming machine or during other gaming activities, is an important consideration for an operator of a gaming establishment.

One related method of gaining and maintaining a game player's interest in game play is loyalty point programs, such as player tracking programs, offered at various casinos. Loyalty point programs provide rewards to players that typically correspond to the player's level of patronage (e.g., to the player's playing frequency and/or total amount of game plays at a given casino). Loyalty point rewards may be free meals, free lodging and/or free entertainment, for example, and other types of rewards may also be used. These rewards may help to sustain a game player's interest in additional game play during a visit to a gaming establishment and may entice a player to visit a gaming establishment to partake in various gaming activities.

In general, loyalty programs may be applied to any game of chance offered at a gaming establishment. An example of a hardware and/or software implementation of a loyalty reward program with respect to a number of gaming machines is described as follows. FIG. 1 is a block diagram of a number of gaming machines with player tracking units connected to servers providing player tracking services. In casino 150, gaming machines 100, 101, 102 and 103 are connected, via the data collection unit (DCU) to the player tracking/accounting server 120. The DCU 106, which may be connected to up to 32 player tracking units in a particular example, consolidates the information gathered from player tracking units in communication with the DCU 106 and forwards the information to a player tracking account server such as 120.

In another casino 151, a different player tracking server 121 is connected to gaming machines 130 and 131. In yet another casino 152, a separate player tracking server 122 is connected to gaming machines 132 and 133. In gaming machine 100 of casino 150, a player tracking unit 107 and slot machine interface board (SMIB) 103 are mounted within a main cabinet 8 of the gaming machine. A top box 130 is mounted on top of the main cabinet 8 of the gaming machine. In many types of gaming machines, the player tracking unit is mounted within the top box 130. Usually, player tracking units, such as 107, and SMIBs, such as 103, are manufactured as separate units before installation into a gaming machine. The player tracking unit 107 includes three player tracking devices, a card reader 24, a key pad 22, and a display 16, all mounted within the unit. The player tracking unit 107 communicates with the player tracking server via the SMIB 103, a main communication board 110 and the data collection unit 106. The player tracking unit 107 is usually connected to the master gaming controller 104 via a serial connection of some type and communicates with the master gaming controller 104 using a communication protocol of some type. For example, the master gaming controller 104 may employ a subset of the Slot Accounting System (SAS) protocol developed by IGT of Reno, Nev. to communicate with player tracking unit 107.

Typically, when a game player wants to play a game on a gaming machine and utilize the player tracking services available through the player tracking unit, a game player inserts a player tracking card, such as a magnetic striped card, into a card reader 24. After the magnetic striped card has been so inserted, the player tracking unit 107 may detect this event and receive certain identification information contained on the card. For example, a player's name, address, and player tracking account number encoded on the magnetic striped card may be received by the player tracking unit 107. In general, a player must provide identification information of some type to utilize player tracking services available on a gaming machine. For current player tracking programs, the most common approach for providing identification information is to issue a magnetic striped card storing the necessary identification information to each player that wishes to participate in a given player tracking program.

After a player has inserted her or his player tracking card into the card reader 24, the player tracking unit 107 may command the display 16 to display the game player's name on the display 16 and also, may optionally display a message requesting the game player to validate their identity by entering an identification code using the key pad 22. Once the game player's identity has been validated, the player tracking information is relayed to the player tracking server 120. Typically, the player tracking server 120 stores player tracking account records including the number of player tracking points previously accumulated by the player.

During game play on the gaming machine, the player tracking unit 120 may poll the master gaming controller 104 for game play information such as how much money the player has wagered on each game, the time when each game was initiated and the location of the gaming machine. The game play information is sent by the player tracking unit 107 to the player tracking server 120. While a player tracking card is inserted in the card reader 24, the player tracking server 120 may use the game play information provided by the player tracking unit 107 to generate player tracking points and add the points to a player tracking account identified by the player tracking card. The player tracking points generated by the player tracking server 120 are stored in a memory of some type on the player tracking server.

As suggested above, a player's incentive for using the player tracking services is awards provided by the gaming machine operator (e.g., the casino). Unfortunately, when player tracking identification information is not provided to the player tracking server 120 via the player tracking unit 107, player tracking points are not accrued for a game player participating in a game play session on gaming machine 100. For example, when a player tracking card is not inserted into the card reader 24, the player tracking card has been inserted incorrectly or the card reader is malfunctioning, a game player may not obtain player tracking points while participating in game play on gaming machine 100. This happens more frequently than one might imagine. Very often a player will forget to bring his/her playing card to a casino, or leave the card in his/her room, or possibly return from the swimming pool without a card and decide to play anyway.

Also, when the player uses a player tracking card that is incompatible with gaming machine 100, such as a player tracking card issued at another casino, player tracking points are not awarded to the player. Typically, each casino implements a player tracking program with player tracking cards that may only be used to earn player tracking points only at the casino where the card was issued. For instance, casino 150 may issue a player tracking card that is only valid at casino 150, casino 151 may issue a player tracking card that is only valid at casino 151, and casino 152 may issue a player tracking card that is only valid at casino 152. In this example, the player may be a member of the player tracking programs available at each of casinos 150, 151 and 152. Thus, when a player tries to use the card issued at casino 151 in casino 150 or in casino 152, the card will not work and the player will not earn player tracking points.

In many gaming establishments, loyalty programs that allow a player to earn “complimentaries” or “comps,” such as free rooms, buffets, meals, shows, merchandise and the like during table game play are very common. A player may earn “comps” for playing table games, such as black jack, baccarat, pai gow poker, keno and roulette. Depending on the gaming establishment, a loyalty program based upon table game play may or may not be combined with a loyalty program based upon slot game play. Comps at table games are awarded using a rating system. To get rated, a player must give their name to a casino service representative every time they sit down to play a table game. The player must supply their name even if they have only moved from one table to an adjacent table. During the player's game play at the table, a casino service representative, such as a pit boss, keeps track of, or rates, the player. This means that the casino service person writes down how much a player buys in for, what his average bet is, how fast they play, how long they play and how much they win or lose. When the player leaves the table their rating is handed in. The game play information from their table gaming session is entered into a computer usually connected a remote server that stores a record of the player's game playing history. If the player then asks for dinner for two at the coffee shop the pit boss can look up their game play history and, based on guidelines, which may vary from casino to casino, decide whether or not a comp is justified. When a comp is justified, the pit boss can offer the player a voucher valid for the requested comp.

Player tracking/comp cards and player tracking/comp programs are becoming more and more popular. They have become a de facto method of doing business at casinos. A player may belong to many different player tracking/comp programs and have many different player tracking cards corresponding to each program to which they belong. For example, a single player may belong to as many as 20-30 separate player tracking programs and have 20-30 player tracking cards. As indicated, a disadvantage of current player tracking programs using player tracking cards is that a game player may simply forget to bring her card, lose her card, bring the wrong card, or forget to insert it into the gaming machine. In each of these cases, the player will fail to earn player tracking points. The casino is deprived of valuable marketing information and loyalty incentive and the player is deprived of awards that would otherwise be provided.

In addition, the larger gaming establishments or operators of today typically own multiple casinos or gaming properties, and thus frequently desire systems with expanded or enhanced capabilities. For example, many of these larger gaming operators have implemented various forms of player tracking cards associated with gaming machine use, with such cards being accepted at a plurality of casino properties, and with such cards being used with an associated central system for player tracking and gaming machine accounting. Such systems conveniently allow larger gaming establishments and affiliated groups of gaming operators to track the gaming activities of patrons across multiple casinos and gaming properties, such that a better knowledge of the various gaming activities, trends and habits of individual patrons can be had.

Examples of such systems and methods can be found, for example, in U.S. Pat. Nos. 5,761,647 and 6,183,362 to Boushy, and U.S. Pat. No. 6,003,013 to Boushy et al., which patents are incorporated herein in their entirety and for all purposes. These references disclose various systems and methods for implementing customer tracking and loyalty programs that involve multiple affiliated properties and the creation or modification of theoretical win profiles for patrons based upon estimated winnings from the expected gaming activities of the patrons. These references acknowledge the value of being able to calculate a theoretical win profile for a patron, and disclose the ability to tie comps to a patron based upon his or her theoretical win profile. These references are limited, however, in that they focus primarily on the gaming activities of patrons and only provide rewards to patrons for such activities.

Another example of a system and method for awarding complimentary rewards associated with gaming activities can be found in U.S. Pat. No. 6,379,247 to Walker et al., which is also incorporated herein in its entirety and for all purposes. This reference discusses the ability to award frequent flier miles to patrons based upon patron participation in gaming activities. Walker is also limited in that its focus is similarly on the gaming activities of patrons, and that it only provides rewards to patrons for such activities. In fact, most references in the player tracking and rewards arts focus on the gaming activities of patrons and/or the provision of player tracking points, loyalty credits and/or rewards to patrons based upon their gaming activities.

Although the tracking and rewarding of patrons for gaming activities is an important aspect of the gaming industry, there are wide variances in the levels of gaming activity from patron to patron. Some patrons are prolific gaming enthusiasts, while others choose not to participate in as many gaming activities. Regardless of their levels of gaming activity, however, all patrons by their nature will have expenditures at a gaming establishment, and thus all patrons have value to the establishment. In fact, a given patron who may choose not to play in any gaming activities may nevertheless accrue a bill of hundreds or thousands of dollars for lodging, food, entertainment and merchandise purchases while staying at a gaming establishment. Because such a patron has a limited level of gaming participation though, he or she would not be appropriately rewarded under a loyalty credits program for gaming activities at the gaming establishment, despite the high value of the patron to the establishment.

Presently there are no known systems that combine rewards for lodging, food and retail purchases with a gaming activity rewards program, whereby the total purchases are converted to loyalty credits identical to and summed with those that are awarded for game play. Such a system would be valuable not only in aiding a gaming establishment to track all expenditures of its patrons, but also in rewarding those patrons who do not participate in as many gaming activities but who nevertheless have large levels of spending while at a gaming establishment. Of course, this also means that there has never been a system that can serve multiple properties directly or indirectly over a wide area network in association with awarding loyalty credits for both gaming activities and purchasing activities such as retail purchases and the like.

While present systems and methods for player tracking and rewards have certainly proved to be important and successful, there is always room for improvement and innovation in these areas. In particular, there exists a desire for improved systems and methods for player tracking that track and reward all patron expenditures within a gaming establishment, and in particular for such systems and methods to involve the use of automated systems networked across a plurality of gaming properties that enable a patron to move across all aspects of a gaming property or set of properties while collecting loyalty credits for all spending at that property or set of properties.

### SUMMARY

It is an advantage of the present invention to provide systems and methods for tracking patrons, differentiating patrons and awarding loyalty credits to patrons of a gaming establishment based upon the overall value of the patrons to the gaming establishment. This is accomplished by introducing methods and instrumentalities that facilitate the tracking and awarding of loyalty credits to patrons for both gaming activities and other purchasing activities associated with the gaming establishment. The resulting system then permits the gaming establishment to create and maintain a theoretical all expenditures profile for each patron, whereby an overall value of each patron to the gaming establishment can be estimated. Patrons can then be comped and otherwise rewarded based at least in part on their theoretical all expenditures profiles.

One of the many advantages realized through the present invention is that the resulting reward system is more comprehensive and thus has a greater tendency to generate loyalty and bring given patrons back to the gaming establishment. Another advantage is that the gaming establishment is better able to track all expenditures of its patrons within the gaming establishment, and thus obtain more detailed information on the spending habits and preferences of each patron. This leads to another advantage, in that the detailed information can then be used to tailor comps and rewards to individual tastes and preferences, such that patrons are generally happier and even more loyal to the gaming establishment, and are thus generally willing to spend and be rewarded and comped more on all purchases and activities across the gaming establishment.

According to one embodiment, the provided system and method involve the awarding of loyalty credits to patrons of a gaming establishment providing a loyalty credits program. Relevant steps in the process used by this embodiment include providing a first loyalty instrument adapted to facilitate the tracking of an amount of loyalty credits attributable to a patron of the gaming establishment, determining that a patron has begun a gaming activity for which loyalty credits are awarded, awarding the patron a first amount of loyalty credits corresponding to his or her participation in the gaming activity, storing this first amount of loyalty credits into an account assigned to the patron or onto the first loyalty instrument, determining that the patron has made a purchase for which loyalty credits are awarded, awarding the patron a second amount of loyalty credits corresponding to the purchase, combining the first amount of loyalty credits and second amount of loyalty credits into a combined amount of loyalty credits, and storing the combined amount of loyalty credits into an account assigned to the patron or onto a combined loyalty instrument adapted for tracking an amount of loyalty credits attributable to the patron. Of course, as in all embodiments disclosed herein, the gaming activity in the context of this application involves the placement of a wager by the patron, the play of a game, and the possibility of a monetary award to the patron based upon the outcome of the game. Further, the purchase involves the procurement of food, lodging, entertainment, transportation, merchandise or services, and the second amount of loyalty credits are in the same units as the first amount of loyalty credits. In addition, the gaming establishment is preferably the sole entity providing the loyalty credits program, and as such controls or authorizes the administration, distribution and redemption of substantially all of the loyalty credits and loyalty instruments.

Detailed versions of this embodiment of the present invention include providing loyalty instruments to the patrons, with examples of such loyalty instruments including smart cards, debit cards, magnetic striped cards, printed tickets, room keys and portable wireless devices. In some instances, the first loyalty instrument and the combined loyalty instrument are the same physical item, with the only difference between the two being that the combined loyalty instrument has been adjusted to reflect the addition of the second amount of loyalty credits. In other instances, these instruments may involve different physical items, such as printed tickets or other devices that are usable only once. In some instances, it may be possible to award loyalty credits without first receiving personal identification information from the patron or otherwise establishing the identity of the patron, regardless of whether the patron already has a loyalty credits account at the gaming establishment. Other detailed variations of this embodiment may include one or more features from one of the other particular embodiments that follow.

According to another particular embodiment, the provided system and method involves awarding customized comps to patrons of a gaming establishment. Relevant steps in the process used by this embodiment include determining that a patron has begun a gaming activity, tracking the participation of that patron in the gaming activity, assigning a first level of consideration to the patron corresponding to the amount of participation in the gaming activity, determining that the patron has made a purchase, tracking the amount of money spent by the patron on the purchase, assigning a second level of consideration to said patron corresponding to the amount of money spent by the patron on the purchase, and awarding a customized comp to the patron based on the first and second levels of consideration. In particular, the second level of consideration is independent of the first level of consideration, and the customized comp is awarded on the initiative of the gaming establishment and without any specific request from the patron for that comp. In detailed variations of this embodiment, various items and features from the foregoing and following particular embodiments may be incorporated, such as the awarding of loyalty credits for the gaming activity, purchase, or both.

According to yet another particular embodiment, the provided system and method involve differentiating patrons of a gaming establishment based upon their expenditures associated with the gaming establishment. Relevant steps in the process used by this embodiment include tracking the gaming activities of a patron, tracking the purchasing activities of that patron, and establishing a theoretical all expenditures profile for that patron based upon at least the gaming activities and the purchasing activities tracked for that patron. These steps are then repeated for another patron, such that a separate theoretical all expenditures profile for this other patron is established based upon at least the gaming activities and purchasing activities tracked for this other patron. The establishment of different theoretical all expenditures profiles then creates a tool whereby various patrons can be differentiated.

In detailed variations of this particular embodiment, a theoretical all expenditures profile for a given patron can reflect an expected value of that patron to the gaming establishment based upon substantially all expenditures of that patron within or about the gaming establishment over a given time interval. In noting substantially all expenditures of the patron associated with said gaming establishment, this can include substantially all gaming activities of the patron within or about the gaming establishment and substantially all instances involving the procurement of food, lodging, entertainment, transportation, merchandise and services by the patron within or about the gaming establishment. Of course, as in the case of all particular embodiments, the gaming establishment can be a casino, a plurality of commonly owned gaming properties, or simply a plurality of gaming properties affiliated by some means, such as through a common loyalty credits program. In other detailed variations of this particular embodiment, various items and features from the foregoing particular embodiments may also be incorporated, such as the awarding of loyalty credits for the gaming activity, purchase, or both. Various details regarding the awarding of customized comps to patrons may similarly be included.

In still another particular embodiment, a loyalty credit system adapted for tracking, differentiating and awarding loyalty credits to patrons of a gaming establishment providing a loyalty credits program is provided. This system can include one or more loyalty credit generation gaming sites configured to generate and issue primary amounts of loyalty credits to patrons based upon the gaming activities of the patrons, one or more loyalty credit generation purchasing sites configured to generate and issue secondary amounts of loyalty credits to patrons based upon the purchasing activities of the patrons, a plurality of loyalty instruments adapted to facilitate the tracking and commingling of primary amounts of loyalty credits and secondary amounts of loyalty credits, and one or more loyalty program servers configured to store loyalty credit system information, to establish theoretical all expenditures profiles for patrons based upon their gaming activities and purchasing activities, and to make recommendations to gaming establishment personnel regarding awards of customized comps to patrons based upon their theoretical all expenditures profiles.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and elements for the disclosed wide area gaming and retail player tracking systems and methods. These drawings in no way limit any changes in form and detail that may be made to the invention by one skilled in the art without departing from the spirit and scope of the invention.

FIG. 1 is a block diagram of a number of gaming machines with player tracking units connected to servers providing player tracking services.

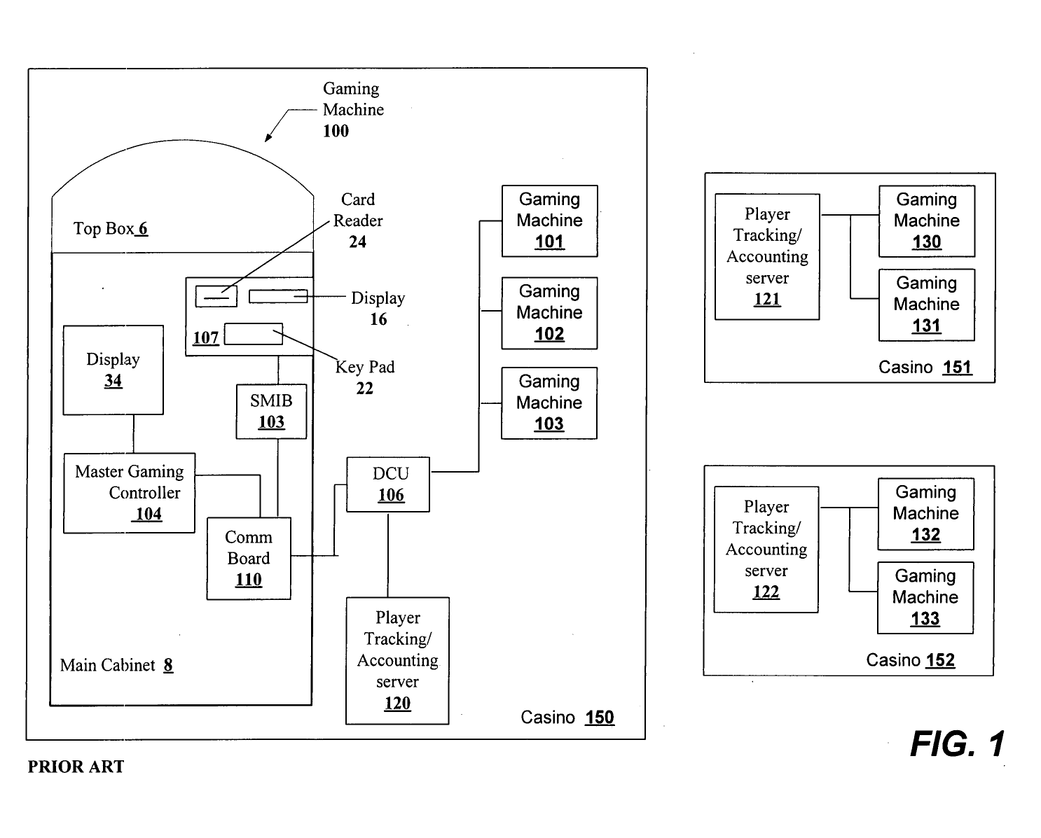

FIG. 2 is a block diagram of a gaming machine connected to a player tracking server and a loyalty program server allowing loyalty program instrument transactions.

FIG. 3 is a block diagram of the components of a loyalty program instrument system for one embodiment of the present invention.

FIG. 4 is a perspective drawing of a video gaming machine of the present invention.

FIG. 5 is a flow chart depicting a method of rewarding loyalty points accrued anonymously on a gaming machine.

FIG. 6 is a flow chart depicting a method for validating information stored on a loyalty point instrument at a validation site connected to a cross validation network as described with reference to FIG. 3.

FIG. 7 is a block diagram of loyalty program systems at multiple gaming properties connected to a loyalty program transaction clearinghouse server.

FIG. 8 is an interaction diagram for a loyalty program instrument transaction between a clearinghouse, loyalty program servers, and loyalty program instrument generators/validators where the loyalty program instrument is generated at a different location from where it is validated.

FIG. 9 is a flow chart depicting a comprehensive method of differentiating patrons and awarding loyalty credits to patrons of a gaming establishment based upon the overall value of the patrons to the gaming establishment.

### DETAILED DESCRIPTION

Exemplary applications of systems and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

In general, the present invention relates to systems and methods for tracking patrons, differentiating patrons and awarding loyalty credits to patrons of a gaming establishment based upon the overall value of the patrons to the gaming establishment. This is accomplished by tracking and rewarding all patron expenditures, including both gaming activities and other purchasing activities. Tracking all patron expenditures allows for the creation and updating of a theoretical all expenditures profile for each patron, whereby an overall value of each patron to the gaming establishment can be estimated. Patrons are then comped and otherwise rewarded based at least in part on their theoretical all expenditures profiles.

Concepts important to many embodiments of this invention include “loyalty points,” “loyalty point sessions,” and “loyalty points initiation events.” In addition, the term “loyalty credits” may be used interchangeably with the term “loyalty points,” particularly where such credits may comprise something other than points. Loyalty points or credits refer to any type of points or credits accrued for participating in designated activities at a gaming establishment. Such establishments include casinos, hotels where gaming activities are provided, stores where gaming activities are permitted, Internet-based gaming activities, and the like. Designated activities include, but are not limited to, gaming activity such as playing gaming machines, card games such as black jack, pai gow poker, baccarat and poker, betting on public event outcomes, table games such as roulette, craps, keno and lotteries, and other such events. Other patronage activities at gaming establishments may also accrue loyalty points or credits. As indicated above, loyalty points represent a form of credit accrued for patronage. The points can be redeemed for a variety of goods or services (or translated to other forms of credit) within a gaming establishment or affiliated establishment. Player tracking points are a typical example of loyalty points or loyalty credits. In a broader sense, “loyalty credits” can refer to any form of “loyalty points,” and can also encompass, for example, actual monetary or cash values, virtual or real coupons or vouchers for tangible items or services, or other items for which the use of points may be awkward or inappropriate. Although many of the following examples and discussions refer to “loyalty points” or “points,” it will be readily understood that such examples and discussion may also include “loyalty credits” or “credits.”

Loyalty point or credit sessions are sessions during which a person is performing the designated activity and during which loyalty points or credits accrue. Such session may be delineated by a first event and a second event (such as the “game events” described above). Importantly, loyalty point (or credit) sessions can be triggered or initiated by events that need not involve conventional player tracking initiation events (e.g., insertions of player tracking cards). Thus, the person can begin accruing loyalty points even if he/she forgets to insert his/her player tracking card or otherwise fails to initiate a conventional player tracking session. Further, it is possible that the entire process is performed anonymously so that the gaming establishment never knows who is accruing the loyalty points (or credits)—or at least not via a conventional player tracking methodology.

Because loyalty point sessions may begin without a conventional player tracking initiation event, a more general concept must be applied to initiation of loyalty point sessions. Preferably such initiation can be automatically detected by a gaming machine or other mechanism at a gaming establishment. (Note however that some activities such as black jack may require that a dealer or other person manually initiate the session.) Examples of events that trigger accrual of loyalty points include a player beginning to play a particular gaming machine, a player providing cash or indicia of credit to a gaming machine, a user actuating a mechanism allowing anonymous gaming activity, etc. Examples of events that can indicate the end of a loyalty points session include winning a jackpot or other conventional gaming award, a user actuating a mechanism indicating an end to the gaming activity, detecting that a particular period of inactivity has elapsed, etc.

As an introduction to the various detailed embodiments described herein, two specific examples of particular implementations according to the present invention will now be provided. It will be readily appreciated that the following examples are merely two selected from a potentially infinite number of possibilities that can occur under the present invention, such that these examples are not limiting in any way.

According to a first example, Patron X is a patron that has registered or otherwise checked in with an existing loyalty credits account under a wide area gaming and retail player tracking system. On a particular day, Patron X enters Casino A and begins play on several gaming machines. Patron X wagers a combined total of $100 on various gaming machine plays and then proceeds to the pit area to play table games. Patron X also wagers a combined total of $100 on various table game plays, and then decides that his gaming session is over. Per its established guidelines and award schedules, Casino A awards 100 loyalty credits to Patron X for his play on the gaming machines, and 50 loyalty credits for his play on the table games.

Patron X then goes to a restaurant within Casino A and spends $100 on dinner, which includes a hot fudge sundae. Per its established guidelines and award schedules, Casino A then awards 10 loyalty credits to Patron X for his dinner purchase, for a grand total of 160 loyalty credits awarded to Patron X on the day. At each gaming machine, gaming table and transaction within the restaurant, Patron X provides his loyalty program card for the award of loyalty credits, and his loyalty credits are awarded directly to his established patron account in the loyalty program server of Casino A. Although Patron X does not redeem any loyalty credits at all on this day, the loyalty program server makes a recommendation to the cashier at the restaurant based on the status and history of Player X within the system, and the cashier then provides Patron X with a coupon for a free hot fudge sundae at an ice cream shop located elsewhere within Casino A. At the end of the day, the account of Patron X in this system has been increased by 160 loyalty credits, and Patron X has been given a valuable food coupon that he did not request.

According to a second example, Patron Y is a patron that has not similarly registered or otherwise checked in with an existing loyalty credits account under a wide area gaming and retail player tracking system. On a given Day 1, Patron Y enters Casino B and purchases several T-shirts and assorted souvenirs at a gift shop within the casino at a combined cost of $200. Because Patron Y does not have a loyalty program card to present to the cashier at the time of purchase, the cashier provides Patron Y with a printed ticket for 10 loyalty credits corresponding to the gift shop purchase. Patron Y then proceeds to the concierge within Casino B and purchases several tour bus tickets for a combined cost of $100. Because Patron Y again does not have a loyalty program card, the concierge similarly provides Patron Y with a printed ticket for 5 loyalty credits corresponding to the purchase of tour bus tickets. Patron Y then proceeds to a ticket services booth within Casino B and purchases several tickets for an entertainment event at a property affiliated with Casino B for a total cost of $120. Since she has no loyalty program card, Patron Y is again given a printed ticket, this time for 60 loyalty credits corresponding to the purchase of entertainment event tickets. Patron Y then departs Casino B with three tickets for 10, 5 and 60 loyalty credits each.

On a subsequent Day 2, which can actually be months or years after the previous Day 1, Patron Y enters an affiliated Casino C and checks in at the hotel front desk. Still not having a loyalty program card, Patron Y is presented with a printed ticket for 200 loyalty credits corresponding to the $400 suite charge for her weekend stay at the Casino C hotel. Patron Y is asked whether she wants to become an official member of the loyalty program for Casino C and all affiliated properties (including Casino B), but she declines at this time. During the check in and presentation of the printed ticket for loyalty credits, the loyalty program server provides the desk clerk with a comp recommendation based upon the suite purchase and location, and Patron Y is presented with a free one-day pass for the Casino C spa closest to her hotel suite.

During her stay, Patron Y presents her printed ticket for 200 loyalty credits at one of the restaurants within Casino C and is awarded a free dessert for these loyalty credits. Upon checking out of the hotel at the end of her stay, Patron Y decides that she will become a registered member of the loyalty program. Patron Y is awarded 50 loyalty credits for registering in the program, and then presents her other printed tickets for 10, 5 and 60 loyalty credits. These printed tickets are taken and their amounts are added to the account of Patron Y on the loyalty program server, such that she then has an account balance of 125 loyalty credits. Upon entering the printed tickets into the system and converting the stored loyalty credits from the tickets to the registered patron account for Patron Y, the loyalty program server also records other information stored on these previously printed tickets and attributes this information to her patron account. After doing so, the server makes a comp recommendation to the check out clerk based on this information, and Patron Y is presented with a coupon for half-off on any T-shirt in any gift shop of Casino C. The account balance of 125 loyalty credits for Patron Y is not affected by the grant of this comp that has not been requested by Patron Y but is nevertheless tailored toward her preferences.

Again, the foregoing examples represent only a few of the myriad possible outcomes and arrangements of player expenditures, tracking and rewards under the inventive systems and methods. The following description will now provide for other possibilities and implementations of these and other such wide area gaming and retail player tracking systems and methods at varying levels. First, a general section with examples of gaming machines and devices, player tracking systems and network configurations is provided. Within this section are discussions regarding the provision, administration and redemption of loyalty programs and loyalty credits in general. A section on providing anonymous loyalty credit awards then follows, with further details as to possible methods and systems for such programs. Finally, systems and methods for tracking, differentiating and awarding loyalty credits to patrons based upon all patron expenditures are provided in a section for all expenditures tracking and rewards.

Gaming Devices Player Tracking Systems and Network Configurations

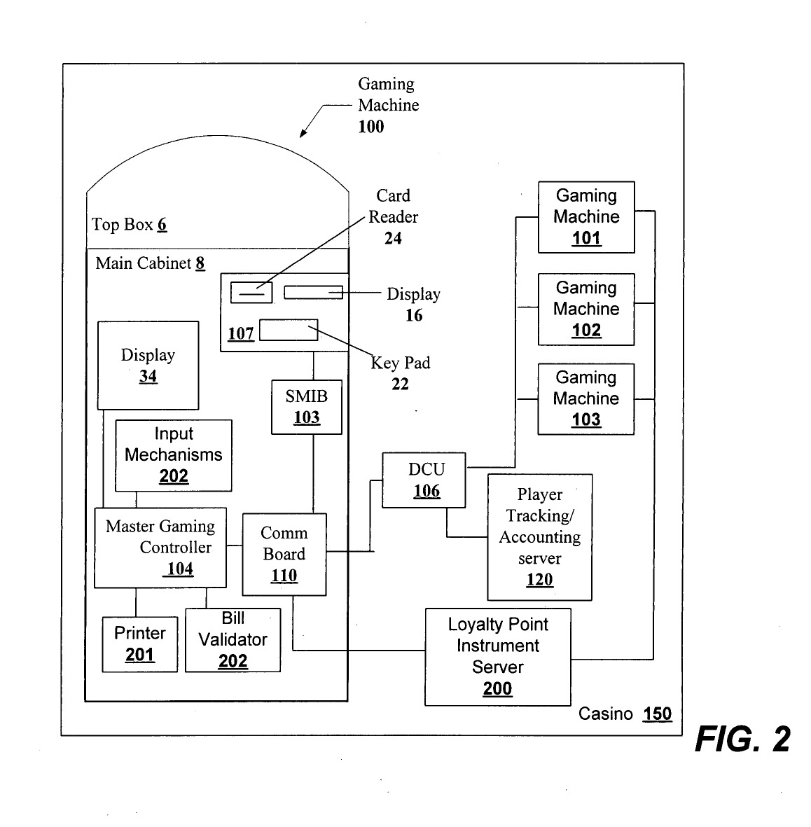

FIG. 2 is a block diagram of gaming machines 100, 101, 102 and 103 connected to a player tracking server 120 and a loyalty program instrument server 200 allowing loyalty program instrument transactions. With the present invention, without providing a player tracking card, player tracking information or any other type of identification information, a player may initiate a game play session on gaming machine 100, play a number of games and receive loyalty points, such as player tracking points. The player may or may not have a player tracking account with the gaming establishment such as casino 150. Note that the “game play session” described here serves as an example of a loyalty points session.

For instance, the player may insert a bill or a bar-coded printed ticket (e.g. an EZPAY™ ticket) into bill validator 202 to register credits on the gaming machine. When credits are registered on the gaming machine 100, a logic device located on the gaming machine 100, such as master gaming controller 104 or a logic device located the player tracking unit 107, may begin to generate loyalty points, such as player tracking points. As another embodiment, when credits are registered on the gaming machine 100, a remote logic device such as a logic device on the player tracking accounting server 120 or a logic device on the loyalty program instrument server 200 may begin to accrue loyalty points. Next, the player, using input mechanisms 202, may make wagers on a number of games presented on the gaming machine and view the game outcomes on display 34. Based upon a manner in which the player participates in game play on the gaming machine 100, such as the amount wagered over a specific period of time, loyalty points may be awarded to the player. A rate at which the player accrues loyalty points may be adjusted according to the following parameters (without limitation thereto): 1) the time of the day, 2) the day of the week, 3) month of the year, 4) a total amount wagered, 5) an amount of time spent playing, 6) a game denomination, 7) a promotional event and 8) a game type.

The amount of loyalty points awarded to the game player is calculated by a logic device located on the gaming machine, by a remote gaming device or combinations thereof When the logic device used to calculate the awarded loyalty points is located remotely, the master gaming controller 104 may transfer certain gaming machine information, such as wager amounts, to the remote logic device. For instance, when the player tracking account server 120 or the loyalty program server 200 calculates the amount of loyalty points awarded during a particular game play session, the master gaming controller 104 may sends game play information to these remote gaming devices. In some embodiments, game play information used to calculate loyalty point awards may be sent from the gaming machine to the player tracking server 120 through the player tracking unit 107 or the information may be sent directly to the loyalty program instrument server 200. In other embodiments, the master gaming controller 104 may calculate the loyalty points awarded during a game play session. Thus, the transfer of game play information to a remote gaming device may not be required.

At the end of the player's game play session, the amount of loyalty points awarded to the player may be stored on a loyalty point instrument such as a printed ticket, a smart card, a debit card, a room key or a portable wireless device. For example, the printer 201 may print a ticket voucher showing the amount of loyalty points awarded to the player during the game play session. The player may later validate the ticket to receive the loyalty points. As another example, loyalty points awarded to the player may be stored on a smart card inserted into the card reader 24. In some embodiments, the loyalty point instrument may simply be used as a receipt to ensure that loyalty point credits earned by the player have been correctly credited to their account.

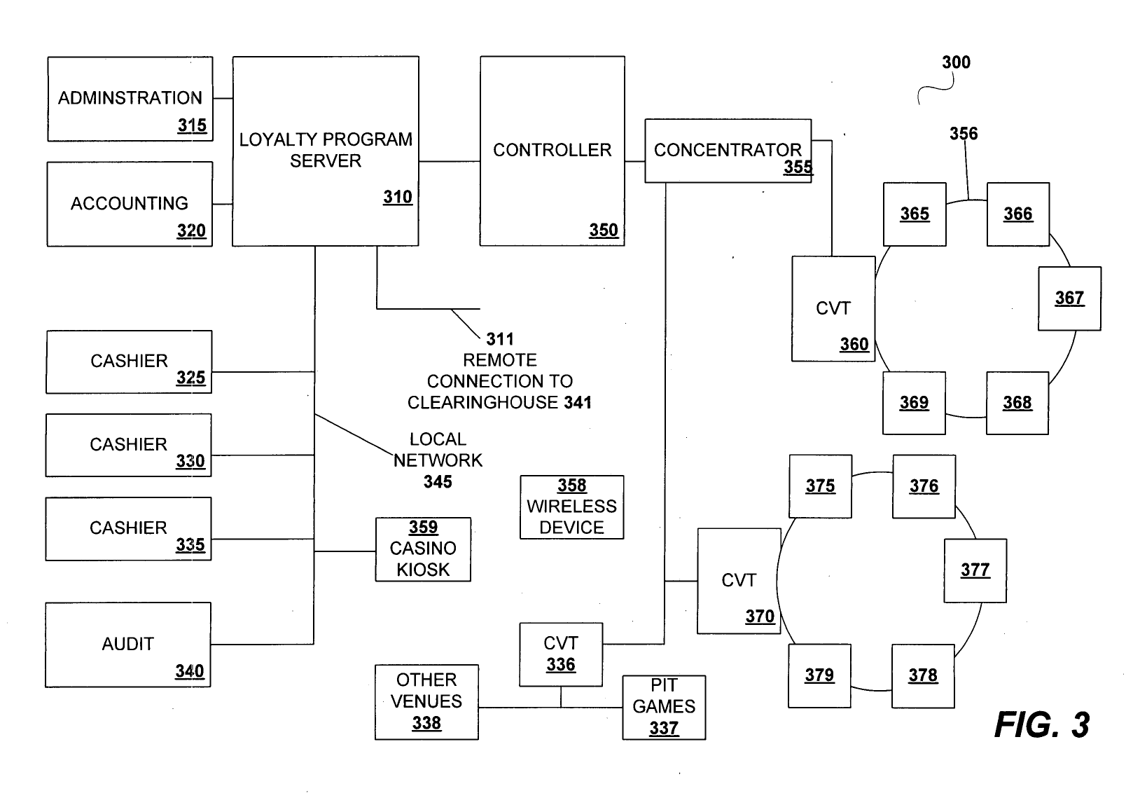

When the loyalty point instrument is issued to the player, various types of transaction information may be recorded on the loyalty point instrument and may also be stored to another memory location on the gaming machine 100, on the loyalty program instrument server 120, on the player tracking server 120 or some other gaming device. Examples of stored transaction information includes an issue time, a date, an instrument number, an instrument type, a machine number, etc. The transaction information stored on the loyalty point instrument and stored at the additional memory location may be compared to validate the loyalty point instrument. For instance, a player may wish to have the loyalty points stored on the ticket voucher to be later credited to their player tracking account or to redeem the points directly for a goods and services item without crediting the player's player tracking account. In some cases, the player may not even have a player tracking account. To credit or to redeem the loyalty points stored on the loyalty point instrument, the transaction is first validated. Specific examples of the loyalty point instrument validation process and other uses of loyalty point instruments are described with respect to FIGS. 3-8.

An advantage of loyalty point instruments of the present invention is that a player may earn loyalty points such as player tracking points from game play on a gaming machine or during other gaming activities without the use of a player tracking card or without providing any identification information. As indicated above, if a player forgets to bring their player tracking card, loses their player tracking card, brings the wrong card, forgets to insert the card into the gaming machine, inserts the card incorrectly into the card reader or the card reader is malfunctioning, the player may be still earning loyalty points such as player tracking points from a game play on a gaming machine. In current player tracking programs, before a player can receive player tracking points, the player must always provide identification information of some type, which is usually stored on their player tracking card. Thus, in any situation where player tracking identification information is not provided by the player, such as in the cases described above where the information is obtained from a player tracking card, the player does not earn player tracking points. These situations are avoided with the present invention.

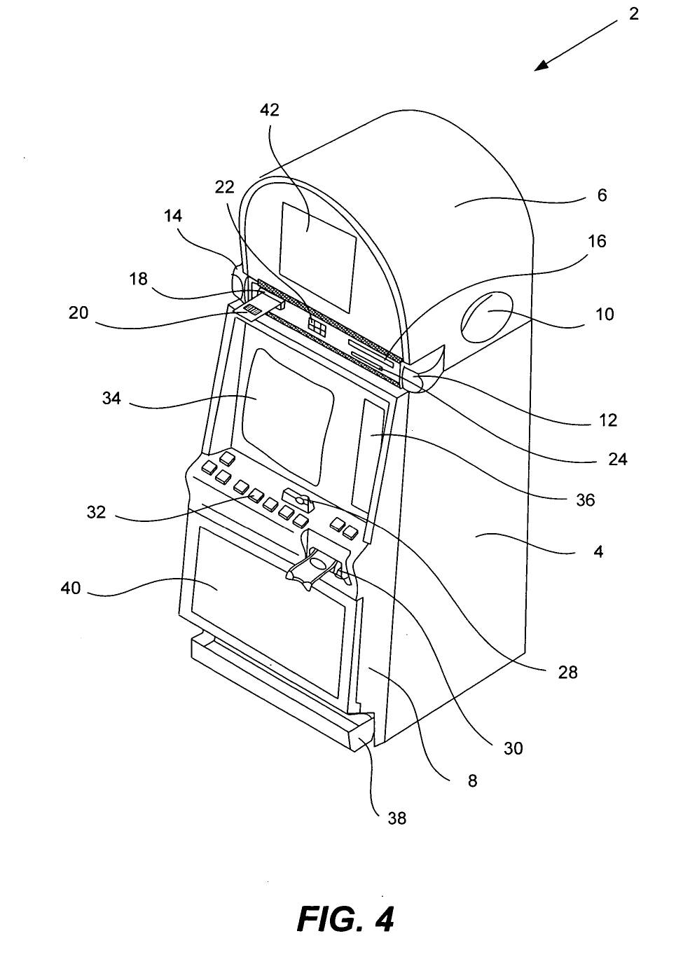

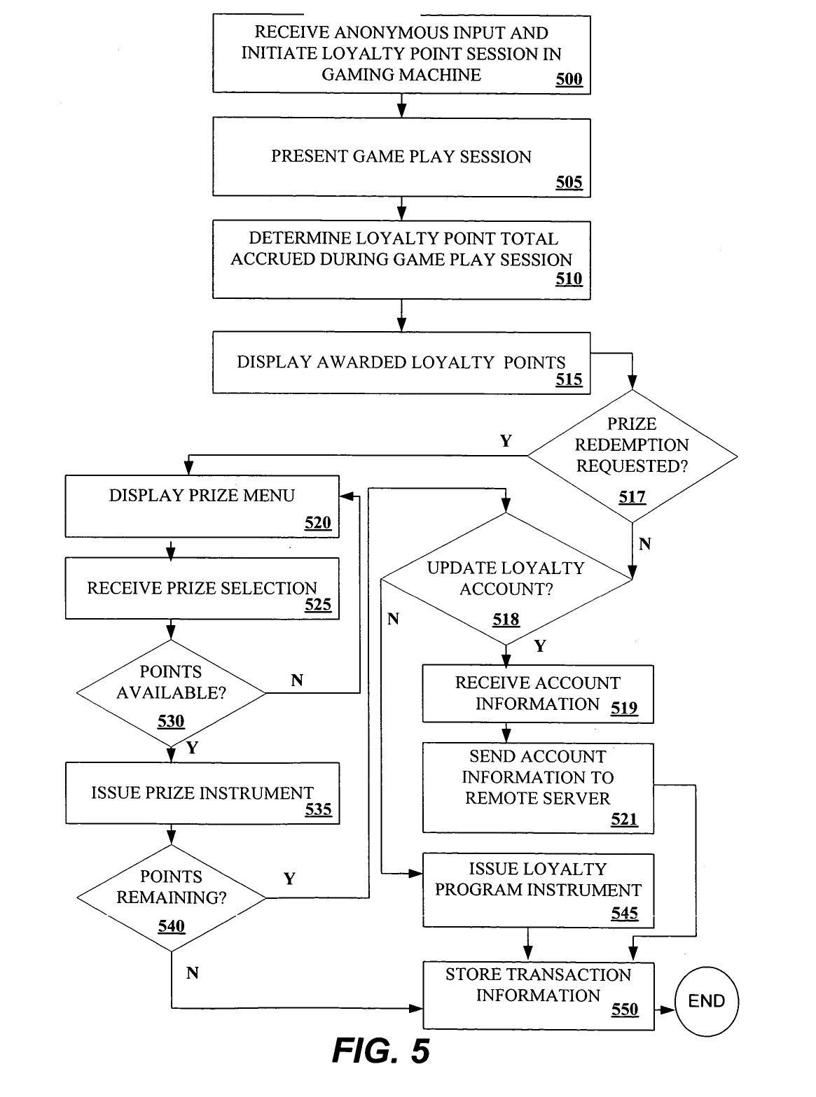

FIG. 3 is a block diagram of the components of a loyalty program instrument system for one embodiment of the present invention. A loyalty program instrument system is the hardware components and software components needed to generate and validate loyalty program instruments. Components of an loyalty program system may include 1) data acquisition hardware, 2) data storage hardware, 3) loyalty program instrument generation and validation hardware (e.g. printers, card readers, ticket acceptors, validation terminals, etc.), 3) auditing software, 4) loyalty program instrument validation software and 5) database software. Many types of loyalty program instrument systems are possible and are not limited to the components listed above. A loyalty program instrument system may be installed at each property utilizing loyalty program instruments. To allow multi-site validations of loyalty program instruments, the loyalty program instruments systems at each property may be linked to a loyalty program transaction clearinghouse. The relation of multiple loyalty program instrument systems connected to a loyalty program transaction clearinghouse are described with reference to FIGS. 4 and 5. The details of the generation and the validation of loyalty program instruments using a loyalty program instrument system at one property are described below with reference to FIG. 3.

In some embodiments of the present invention, the loyalty program instrument system may be implemented in conjunction with a cashless system that generates cashless instruments. Thus, a single instrument generation site may issue both cashless instruments and loyalty program instruments. For example, a gaming machine may issue printed tickets with a cash value that may be redeemed for cash or gaming credits as part of a cashless system or a gaming machine may issue printed tickets with a loyalty point value or a prize value that may be redeemed for goods and services as part of a loyalty program instrument system. Further, a single generation site may issue a plurality of different instrument types for cashless transaction and loyalty program transaction such as but not limited to smart cards, printed tickets, magnetic striped cards, room keys and portable wireless devices. In addition, a single validation site may accept and validate both cashless instruments and loyalty program instruments such as but not limited to smart cards, printed tickets, magnetic striped cards, room keys and portable wireless devices. An example of a cashless system that may be modified to implement both cashless instruments and loyalty point instruments with the present invention is the EZPAY™ system manufactured by IGT of Reno, Nev.

Details of apparatuses and methods used to validate a cashless instruments and that may be applied to the validation of a loyalty point instruments are described in co-pending U.S. application Ser. No. 09/544,884 by Rowe et al. filed Apr. 7, 2000, entitled “Wireless Gaming Environment,” which is incorporated herein in its entirety and for all purposes. Details of apparatuses and methods used to validate a cashless instrument across multiple gaming properties and may be applied to the validation of a loyalty point instrument across multiple gaming properties are described in co-pending U.S. application Ser. No. 09/684,382 by Rowe filed Aug. 25, 2000, entitled “Cashless Transaction Clearinghouse,” which is incorporated herein in its entirety and for all purposes. Details of apparatuses and methods of using a smart card as a cashless instrument, at a single gaming property or across multiple gaming properties, that may be applied to the use of a smart card as a loyalty point instrument, at a single gaming property or across multiple gaming properties, are described in co-pending U.S. application Ser. No. 09/718,974 by Rowe filed Nov. 22, 2000, entitled “EZPAY™ Smart Card and Ticket System,” which is incorporated herein in its entirety and for all purposes. Details of apparatuses and methods for providing secure transactions for a cashless system that may be applied to a loyalty program instrument system are described in co-pending U.S. application Ser. No. 09/660,984 by Espin et al. filed Sep. 13, 2000, entitled “Transaction Signature,” which is incorporated herein in its entirety and for all purposes.

Returning to FIG. 3, a first group of gaming machines 365, 366, 367, 368, and 369 is shown connected to a first clerk validation terminal (CVT) 360 and a second group of gaming machines, 375, 376, 377, 378 and 379 is shown connected to a second CVT 370. The clerk validation terminals are used to store loyalty program transaction information generated when a loyalty program instrument is issued at a generation site such as a gaming machine. The loyalty program transaction information, which may be stored each time a loyalty program instrument is issued, may include but is not limited to prize information, loyalty point information, an establishment, a location, a bar code, a instrument type (e.g. ticket, smart card, room key, magnetic card, portable wireless device, etc.), an issue date, a validation number, an issue time, an instrument number, an instrument sequence number and a machine number. Also, the loyalty program transaction information may include transaction status information such as whether the loyalty program instrument has been validated, is outstanding or has expired. Some of the loyalty program transaction information stored in the CVT may also be stored on the loyalty program instrument as loyalty program instrument information. When a loyalty program instrument is validated, the information stored in the CVT and the information stored on the loyalty program instrument may be compared as a means of providing secure loyalty program transactions.

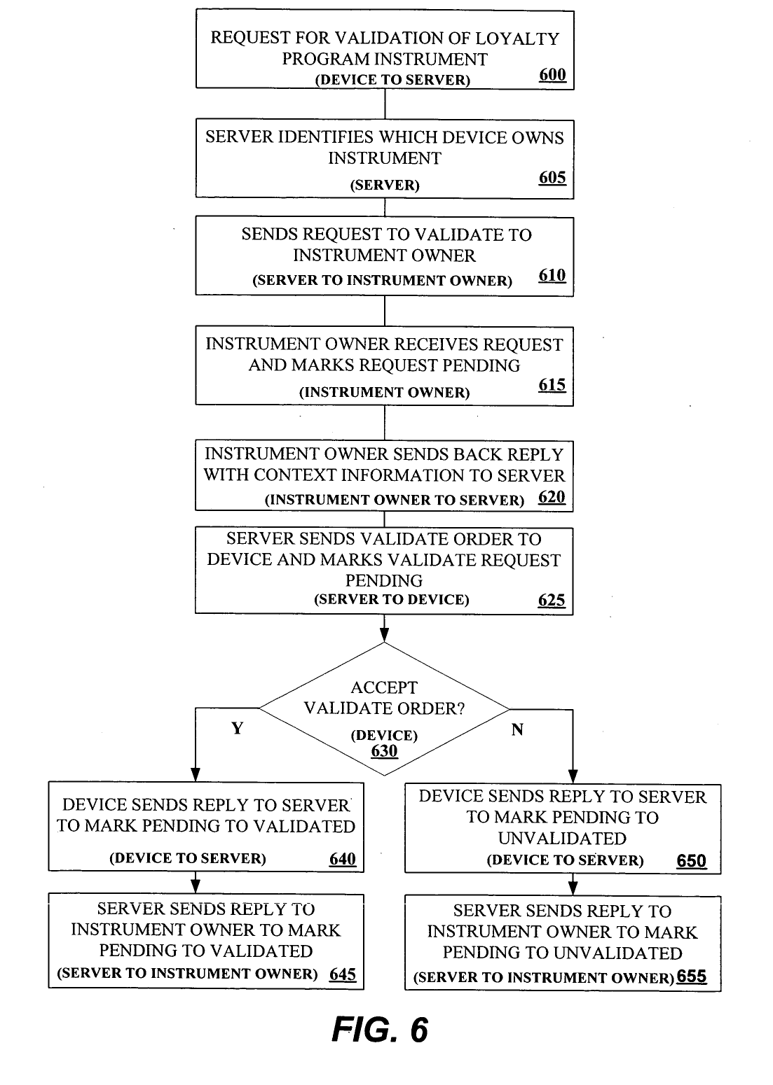

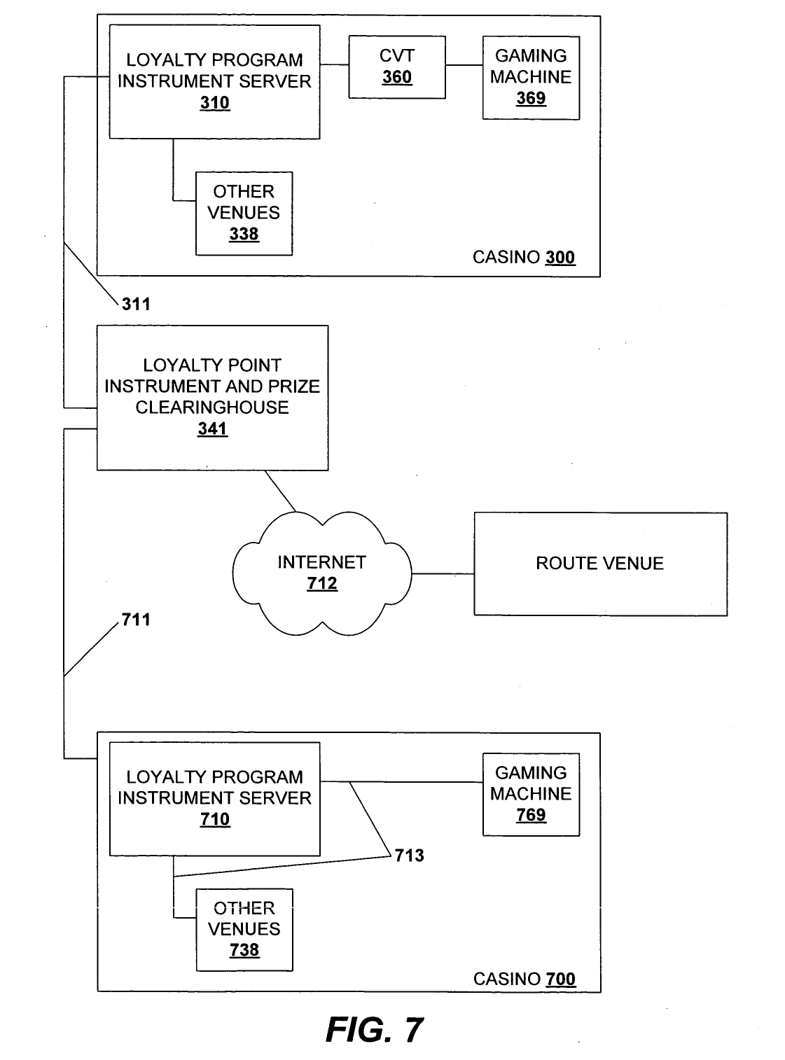

As described with reference to FIG. 2, all of the gaming machines are designed or configured to accrue loyalty points during a game play session, award a player some or all of the accrued loyalty points and store loyalty program information to a loyalty program instrument, such as a printed ticket, a magnetic striped card, a room key, a portable wireless device or a smart card, which is issued to the game player. The loyalty program instruments, as part of a loyalty program available at property 300, may be redeemed for goods and services. In addition, the gaming machines and other loyalty program validation sites at property 300 may accept loyalty program instruments issued at a different property from property 300 where the different property utilizes the same or a different loyalty program instrument system as compared to property 300. Details of a multi-site loyalty program instrument system are described with respect to FIGS. 6 and 7.

A player may participate in a number of activities at the gaming establishment of property 300 for which the player can earn loyalty points. For instance, loyalty points may be earned while playing a game of chance at pit games 337, while playing one of the gaming machines, or while making a food purchase, an entertainment purchase, a transportation purchase, a lodging purchase, a merchandise purchase or a service purchase at one of the other venues 338 at property 300. Further, food purchases, entertainment purchases, transportation purchases, lodging purchases, merchandise purchases and service purchases that earn loyalty points for a patron may be made at venues outside of traditional gaming establishments but in affiliation with a gaming establishment. For instance, a patron may make a food purchase at a restaurant affiliated with a gaming establishment or may make merchandise purchase with a retailer affiliated with the gaming establishment. After their purchase, the patron may be issued a loyalty point instrument with a number of loyalty points that may be redeemed for goods, services and comps or may be later added to a loyalty point account of the patron. Affiliated venues that issue loyalty point instruments may be linked to a loyalty program server, such as 310, via the Internet (see FIG. 7).

As another example, a player, without providing identification information such as player tracking information or comp information, may be identified at a pit game. After rating the players manner of game play over a certain period of time (e.g. amount bet), the player may be awarded a loyalty point instrument storing loyalty points, such as a printed ticket, earned during their pit game play. The loyalty point instrument may be later exchanged by the player for a comp, such as free meal at casino buffet. In another embodiment, when player comp information has been provided by the player, the loyalty point instrument may be used as a receipt that is designed to allow the player to verify that their game play has been both correctly rated and correctly entered into the comp system.

After each activity, a player may be issued 1) a new loyalty program instrument storing the loyalty points earned for the activity or 2) an existing loyalty program instrument may be updated to store additional loyalty points. For instance, the existing loyalty program instrument may be, a smart card, already storing loyalty points earned from previous activities. The smart card may be modified to store additional loyalty points after each new activity. Accumulated loyalty points earned by a player and stored on a loyalty program instrument may be used to obtain goods, services and comps at various loyalty program validation sites at property 300, such as but not limited to: i) gaming machines, ii) cashier stations 325, 330, 335, iii) a casino kiosk 359, iv) from a casino service person with a hand-held wireless device 358 and v) at a clerk validation terminal 360 or 370.

In general, user interfaces for viewing and modifying loyalty point accounts may be displayed on many different types of computing devices such as gaming machines, personal digital assistants, home computers linked to remote sites via the Internet, a kiosk located in a casino, a phone and a video display interface. In one embodiment, a video display interface may be a television monitor located in a hotel room. The hotel rooms may be linked by a local intranet to the loyalty program server 310. A touch screen, control pad or some other input device may be used with the television monitor to provide input to the loyalty point account user interface.

A game player may wish to use a loyalty program instrument issued during one activity during another activity at property 300. For example, a game player may a participate in a pit game 337 such as craps, roulette, black jack, etc., and may be issued a loyalty point instrument, such as a printed ticket, with a number of loyalty points based upon the manner in which they participated in the activity such as an amount wagered over a particular amount of time. Next, the player may desire to use the loyalty point instrument during another activity such as a game play session on one of the gaming machines 365, 366, 367, 368, 369, 375, 376, 377, 378 and 379. After the loyalty point instrument has been validated, as described below, the loyalty points stored on the loyalty point instrument may be used by the player to redeem prizes, goods, or services available on the gaming machine. In one embodiment, for promotional purposes, only particular prizes, goods or services may be available on particular gaming machines to encourage game play of those machines. In another embodiment, a player may redeem loyalty points stored on a loyalty point instrument to access a special bonus features or game play features on a gaming machine. For example, after the play has been issued a printed ticket with loyalty points during one activity, the player may initiate a game play session on a gaming machine by entering the printed ticket into a bill validator on the gaming machine. After a given ticket has been validated, as described below, some or all of the loyalty points stored on the printed ticket may be used to access a special bonus game or a special game play feature available on the gaming machine such as a chance to win a special jackpot. For instance, a player may commit five hundred loyalty points earned from a lodging purchase, stored on a loyalty program instrument, to activate a bonus feature on a gaming machine.

In yet another embodiment, for convenience, a player may desire to combine loyalty points earned from a plurality of activities, such as gaming machine play, pit game play, merchandise purchases, etc., and stored on multiple loyalty program instruments onto a single loyalty program instrument. For example, a player may be issued a printed ticket or another type of loyalty program instrument from a gaming machine after a first game play session. At beginning of a second game play session, on the same or a different gaming machine, the player may insert the printed ticket into the gaming machine. After validating the ticket, the gaming machine may add any loyalty points stored on the ticket to any loyalty points earned by the player during the second game play session and issue a new loyalty point instrument, such as a printed ticket, with combined loyalty points.

Since loyalty points may be redeemed for goods and services, the loyalty points may be considered as having a “cash value” of some type. Thus, since the loyalty points have a “cash value,” it is important to prevent fraud, such as validating a single ticket multiple times or validating a duplicate copy of an already validated ticket, and to provide accounting means for tracking unvalidated and validated tickets. To prevent fraud and to provide accounting for loyalty program instruments, generation sites and validation sites for loyalty point instruments, such as but not limited gaming machines, casino kiosks, cashier stations, clerk validation terminals, pit games and wireless gaming devices, may 1) when a loyalty program instrument is generated at generation site, store loyalty program transaction information to both the loyalty program instrument and to a memory location separate from the loyalty program instrument and 2) when a loyalty program instrument is validated, loyalty program transaction information stored on the loyalty program instrument may be compared with loyalty program transaction information previously stored at the memory location.

In one embodiment of the present invention, a clerk validation terminal (CVT), such as 336, 360 and 370, may be connected to a number of gaming devices that generate loyalty program instruments and the CVT may store loyalty program transaction information each time a loyalty program instrument is generated by one of the gaming devices connected to the CVTs issues a loyalty point instrument. For instance, CVT 360 is connected to gaming machines, 365, 366, 367, 368 and 369 in ring 356. The gaming machines 365, 366, 367, 368 and 369 may issue printed tickets as a loyalty program instrument. Each time one of the gaming machines issues a printed ticket, loyalty program transaction information describing the loyalty program transaction may be stored to the CVT and printed on the ticket.

When the CVTs are not connected to one another or the gaming machines are not linked together in some manner, a loyalty program instrument from one gaming machine may be only be accepted in another gaming machine which is in a group of gaming machines connected to the same clerk validation terminal. For example, a loyalty program instrument issued from gaming machine 365 might be accepted at gaming machines 366, 367, 368 and 369, which are each connected to the CVT 360, but not in gaming machines 375, 376, 377, 378, and 379, which are each connected to the CVT 370. In an analogous manner, when the cashless systems from one property are not connected together then a loyalty program instrument generated from gaming machine 366 may be not be used at property different from property 300.

The CVTs, 336, 360 and 370, store loyalty instrument transaction information corresponding to the outstanding loyalty program instruments, including ticket vouchers, smart cards and debit cards, that are waiting for redemption. The CVTs may also store cashless instrument transaction information. In this embodiment, the CVTs are separate from the gaming machine. However, the loyalty program transaction information may be also be stored within each gaming machine or one gaming machine may functionally act as a CVT for a group of gaming machines eliminating the need for separate CVT hardware. In addition, loyalty program transaction information may be stored in a loyalty program server 310. As previously described, the loyalty program server may be an EZ PAY™ server that also supports cashless instrument transactions.

As described above, the loyalty program transaction information may be used when the loyalty program instruments are validated in some manner such as for a prize redemption or to credit the points to a loyalty point account. The CVTs 336, 360 and 370 may store the information for the ticket vouchers printed by the gaming machines connected to the CVT. For example, CVT 360 stores ticket voucher information for ticket vouchers printed by gaming machines 365, 366, 367, 368, and 369. When a ticket is printed out or a loyalty point instrument is issued in some other manner, loyalty program transaction information is sent to the CVT using a communication protocol of some type from the gaming machine. For example, the gaming machine may send transaction information to the CVT which is part of the cashless system using the slot data system manufactured by Bally's Gaming Systems (Alliance Gaming Corporation, Las Vegas, Nev.) or the slot acquisition system manufacture by IGT, Reno, Nev.

In the present invention, when a player wishes to redeem a ticket or a loyalty program instrument of some other type, the player may redeem vouchers printed from a particular gaming machine at the CVT associated with the gaming machine or any other CVT which is part of the loyalty program instrument system associated with the CVT. For example, since CVT 360 and CVT 370 are connected as part of a single cashless system to the EZ pay server 310, a player may redeem loyalty program instruments or utilize loyalty program instruments at the gaming machines, the CVTs (336, 360 or 370), the cashiers (325, 330 and 335), the casino kiosk 359, the other venues 338 or the wireless cashiers 358. To redeem a loyalty program instrument, the loyalty program instrument is validated by comparing information obtained from the instrument with information stored within the CVT or other gaming devices which behaves functionally as a CVT. After the loyalty program instrument has been redeemed, the CVT marks the instrument paid in a database to prevent an instrument with similar information from being cashed multiple times.

Again, not all loyalty program systems may utilize CVTs, many of the functions of the CVT may be transferred to the cashless server, including the loyalty program server 310, eliminating the transferred function within the CVT. For instance, the cashless instrument transaction information may be stored in the loyalty program server 310 instead of the CVTs. Thus, the need to store loyalty program transaction information within the CVT may be eliminated.

In this embodiment, multiple groups of gaming machines connected to CVTs, such as 355 and 370, and other gaming devices in the other venues 338 and the pit games 337 connected to CVT 336 are linked together in a cross validation network 345. The cross validation network is typically comprised of one or more concentrators 355 which accepts inputs from two or more CVTs and enables communications to and from the two or more CVTs using one communication line. The concentrator 355 is connected to a front end controller 350 which may poll the CVTs for loyalty program transaction information. The front end controller 350 is connected to an Loyalty Program server 310 which may provide a variety of information services for the loyalty program instrument system including accounting 320, administration 315 and loyalty program account maintenance.

In this invention, the loyalty program server is a hardware and a software platform allowing loyalty program instruments to be utilized at all of the loyalty program validation sites (e.g. cashier stations, gaming machines, wireless cashiers and CVTs) within the single property 300. The loyalty program server 310 may also be used to provide multi-site validation of loyalty program instruments via a connection 311 such as a network interface to a remote loyalty program transaction clearinghouse. The loyalty program server is a communication nexus in the cross validation network. For instance, the loyalty program server 310 is connected to the cashiers, wireless devices, remote cashless instrument transaction clearinghouse, CVTs and the gaming machines and other gaming devices via the CVTs.

The cross validation network allows loyalty program instruments generated by any gaming machine connected to the cross validation network to be accepted by other gaming machines in the cross validation network 345. Additionally, the cross validation network allows a cashier at a cashier station 325, 330, and 335 to validate any ticket voucher generated from a gaming machine within the cross validation network 345. As an example, to redeem a loyalty program instrument for goods and services, a player may present the instrument at one of the cashier stations 325, 330, and 335, the casino kiosk 359 or to a game service representative carrying a wireless gaming device 358 for validating loyalty program instruments. Loyalty program transaction information obtained from the instrument is used to validate the instrument by comparing information on the instrument with information stored on one of the CVTs connected to the cross validation network. In addition, when the loyalty program instrument was issued at another property, the information on the instrument may be stored at the other property. Thus, to validate the loyalty program instrument, the loyalty program server 310 may have to communicate with the loyalty program transaction clearinghouse 341 via the remote connection 311 to obtain the information necessary to validate the instrument.

As loyalty program instruments are validated, this information may be sent to audit services computer 340 providing audit services, the accounting computer 320 providing accounting services or the administration computer 315 providing administration services. In another embodiment, all of these services may be provided by loyalty program server 310 which may also be an EZPAY™ server. Examples of auditing services, which may be provided by loyalty program system software residing on the auditing computer 340 include 1) session reconciliation reports, 2) soft count reports, 3) soft count verification reports, 4) soft count exception reports, 5) machine instrument status reports and 5) security access report. Examples of accounting services, which may be provided by cashless system software residing on the accounting computer 320 include a) instrument issuance reports, b) instrument liability reports, expired instrument reports, c) expired instrument validation reports and d) instrument redemption reports. Examples of administration services, which may be provided by loyalty program system software residing on the administration computer 315 include i) manual loyalty program instrument receipt, ii) manual loyalty program instrument report, iii) loyalty program instrument validation report, iv) interim validation report, v) validation window closer report, vi) voided loyalty program instrument receipt and vii) voided loyalty program instrument report.

In another embodiment of the present invention, two or more gaming machines, such as 365, 366, 367, 368 and 369, may be linked together to allow loyalty points earned during the simultaneous game play of the two or more linked gaming machines to be combined on a single loyalty point instrument. Thus, a single game player playing two or more linked gaming machines simultaneously or a couple playing two or more linked gaming machines simultaneously may be able to receive a single loyalty point instrument issued from one of the linked gaming machines for their game play on all of the linked gaming machines. In another embodiment, based upon the combined amount of game play for two or more gaming machines linked together, the rate of loyalty points accrued may be increased. Thus, a couple playing together on two or more linked gaming machines simultaneously or a single person playing two or more linked gaming machines simultaneously may be able to earn more loyalty points than when playing on two or more non-linked gaming machines simultaneously.

Turning to FIG. 4, more details of using loyalty program instruments in the context of game play on a gaming machine are described. In FIG. 4, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, the number of coins played. The bill validator 30, player-input switches 32, video display monitor 34, and information panel are devices used to play a game on the game machine 2. The devices are controlled by circuitry (see FIG. 2) housed inside the main cabinet 4 of the machine 2. Many possible games, including traditional slot games, video slot games, video poker, video black jack, video keno, video pachinko, lottery games and other games of chance as well as bonus games may be provided with gaming machines of this invention.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which may print bar-coded tickets 20 used as loyalty point instruments or cashless instruments, a key pad 22 for entering player tracking information, a florescent display 16 for displaying player tracking information, a card reader 24 for entering a magnetic striped card containing player tracking information. Further, the top box 6 may house different or additional devices than shown in FIG. 4. For example, the top box may contain a bonus wheel or a back-lit silk screened panel which may be used to add bonus features to the game being played on the gaming machine. During a game, these devices are controlled and powered, in part, by circuitry, such as a master gaming controller (see FIG. 2), housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have two or more game displays—mechanical and/or video. And, some gaming machines are designed for bar tables and have displays that face upwards. Still further, some machines may be designed entirely for cashless systems. Such machines may not include such features as bill validators, coin acceptors and coin trays. Instead, they may have only ticket readers, card readers and ticket dispensers. Those of skill in the art will understand that the present invention, as described below, can be deployed on most any gaming machine now available or hereafter developed.

Returning to the example of FIG. 4, when a user wishes to play the gaming machine 2, he or she inserts cash through the coin acceptor 28 or bill validator 30. In addition, the player may use a cashless instrument of some type to register credits on the gaming machine 2. For example, the bill validator 30 may accept a printed ticket voucher, including 20, as an indicia of credit. As another example, the card reader 24 may accept a debit card or a smart card containing cash or credit information that may be used to register credits on the gaming machine. In addition, the player may use a loyalty program instrument, such as smart card, ticket voucher, or debit card, to register previously accumulated loyalty points on the gaming machine. Typically, the information contained on the cashless instrument or loyalty point instrument, including the ticket voucher, smart card or debit card, is validated by a cashless system or loyalty program system. As described above, the cashless system and loyalty program may be a single or separate systems in the present invention. The loyalty program instrument, including but not limited to a ticket voucher, smart card or debit card, may have been generated at the same property, for example a first casino where the gaming machine 2 is located or the instrument may have been generated at another property for example a second casino.

As described above, on a gaming machine, loyalty points may be redeemed for a number of purposes such as to access a special bonus feature available on the gaming machine or to obtain goods and services. The loyalty program instrument typically contains information used to register loyalty points on the gaming machine, including gaming machine 2, and validate the registration transaction. For example, when a ticket voucher is used as a loyalty program instrument, the printed ticket voucher may contain information including but not limited to: 1) a ticket value, 2) a ticket issue date, 3) a ticket issue time, 4) a ticket transaction number, 5) a machine ID, 6) a ticket issue location and 7) a ticket sequence number. Information such as the ticket value, the ticket issue date, the ticket issue time, the ticket number and the machine ID may be common to loyalty program systems that generate and validate tickets issued at a single property. However, information such as the ticket issue location and other information may be needed to allow multi-site generation and validation of loyalty program instruments. In addition, other types of information, besides the information listed above, may be stored on the loyalty program instrument. For example, the ticket may contain information regarding a promotional prize that may be redeemed for loyalty points by the player when the ticket voucher is utilized in the gaming machine 2. As another example, the ticket may contain information such as a number of additional loyalty points that are needed to obtain a particular goods or services item.

The information on the loyalty program instrument may be recorded on the loyalty program instrument when the loyalty instrument is generated. For example, in the case of the ticket voucher, the generation of the ticket voucher may refer to the actual printing of the ticket voucher on paper or some other medium. A unique bar-code may be printed on the ticket voucher which may be read with a bar-code scanner to obtain information from the ticket. The ticket voucher, including 20, may be printed from a printer, including printer 18. In the case of the smart card or debit card, the generation of the smart card or debit card refers to storing or encoding this information on the smart card or debit card. The generation of the debit card or smart card may occur when the smart card or debit card is inserted into the card reader 24 in the gaming machine 2 or at another site where smart cards or debit cards are issued. For example, smart cards or debit cards may be generated at ATM like terminals, at a cashier station when a player cashes out or prepaid smart cards or debits may be purchased within the gaming property (e.g. casino). As another example, the gaming machine may transfer loyalty point information to portable wireless device worn by the player via a wireless interface (not shown) on the gaming machine 2. After a game play session where an amount of loyalty points have been awarded to the player, the amount of loyalty points awarded to the player and any other loyalty points input into the gaming machine may be downloaded to the portable wireless device worn by the player via the wireless interface.

A game play session where loyalty points are accrued by the master gaming controller on gaming machine 2 or by another logic device located on the gaming machine 2 may occur after a particular game event initiated by a game player. For example, a loyalty point session, where loyalty points are accrued, may be triggered by one or more of the following game events: a) depositing an indicia of credit into the gaming machine [e.g., inserting a cashless instrument into the card reader 24], b) inserting a bill or a cashless instrument into the bill validator 30, or inserting a coin in the coin acceptor 28, c) activating an input button on the gaming machine [e.g., input buttons 32], d) inputting a loyalty program instrument into a gaming device on the gaming machine [e.g. inserting an instrument in the bill validator 30 or the card reader 24], e) entering a code into the gaming machine [e.g., via the key pad 22 or via a touch screen] and f) combinations thereof In the present invention, when the gaming machine has not received identification information from the gaming player, such as but not limited to a player tracking account information, loyalty points may be still be accrued during the game play session. The game play session where loyalty points are accrued may end following another game event such as but not limited to i) detecting zero credits registered on the gaming machine, ii) the gaming machine remaining idle for an amount of time, iii) detecting a tilt condition or detecting an error condition on the gaming machine, iv) detecting a game player's request for a loyalty program instrument and v) combinations thereof After the loyalty point session ends, some or all of the loyalty points accrued during the session may be awarded to the game player. The loyalty points may be awarded to the player by storing the points to a loyalty program instrument which is issued to the player or the awarded points may be credited to the player's player tracking account after the player provides identification information to the gaming machine.

During the course of a game play session, a player may be required to make a number of decisions, which affect the outcome of one or more games played during the game play session. For example, a player may vary his or her wager on a particular game, select a prize for a particular game, or make game decisions which affect the outcome of a particular game. The player may make these choices using the player-input switches 32, the video display screen 34 or using some other device which enables a player to input information into the gaming machine. During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40.

After the player has completed a game play session, a loyalty program instrument or cashless instrument may be generated at the gaming machine 2. The loyalty program instrument or cashless instrument may be a printed ticket voucher, a smart card, debit card or other cashless medium. Prior to issuing the instrument, the loyalty points awarded to the player may be displayed on the main display 34, the secondary display 42 or the player tracking display 16. Also, a prize menu may be displayed on one or more displays on the gaming machine 2 such as the main display 34, the secondary display 42 or the player tracking display 16. The prize menu may include one or more goods and services items. To redeem a particular prize, a particular amount of loyalty points is needed. As service items, the game player may be able to convert the awarded loyalty points to frequent flyer miles, obtain a free meal with the loyalty points or obtain a free nights lodging with the loyalty points. As an example of goods items, a player may be able to redeem loyalty points for clothes, food items, electronic goods, etc.

In some embodiments, the player may be transfer the awarded loyalty point to a player tracking account. After providing account information (e.g., by inserting a player tracking card), the player tracking points may be transferred to a player tracking account of the player directly on the gaming machine (see FIG. 5) . In other embodiments, the player may credit player tracking points or loyalty points, stored on a loyalty point instrument, to a player tracking account 1) over the phone, 2) at a clerk validation terminal, 3) at a cashier station, 4) at a casino kiosk, 5) via a web-interface, 6) via mail or 7) through a hand-held wireless device.

The game player may select one of the goods and services items from the prize menu using an input mechanism of some type. For instance, the prize menu may be displayed on a touch screen and the player may touch the screen to select one of the goods and services items. When the amount of loyalty points required to redeem the selected prize is less than an amount of loyalty points available on the gaming machine, a loyalty program instrument containing the prize instrument may be issued. For instance, when loyalty points are redeemed for a free meal, the player may be issued a ticket 22 from printer 18 which may be used to obtain a free meal when presented at one or more restaurants listed on the ticket.

In some embodiments of the present invention loyalty points accrued during the game play session may be combined with previously earned loyalty points to redeem a prize. Thus, loyalty points stored in one or more of a player's loyalty program accounts, such as a player tracking account, or loyalty points earned during other activities stored on one or more loyalty program instruments available to the payer may be used to redeem prizes on the gaming machine. For instance, the player may insert five printed tickets containing various amounts of loyalty points into the gaming machine 2 using the bill validator 30. After each ticket has been validated, as described with reference to FIG. 3, the loyalty points stored on each ticket may be added to the amount loyalty points available on the gaming machine. As another example, the player may request that loyalty points be deducted from a loyalty program account such as a player tracking account. In this case, the gaming machine may send a message to remote server storing the loyalty point account information and request that some amount of loyalty points be deducted from the player's account. Assuming the amount of requested points is available, the requested points may be deducted from the player's account and then transferred to the gaming machine. Finally, the method described above, may be implemented when the player has not accrued any loyalty points during a particular game playing session. For instance, the player may desire to redeem a prize using one or more loyalty program instruments storing loyalty points previously earned by the game player.

In another embodiment of the present invention, a single instrument may store both cash transaction information and loyalty program information. For instance, a smart card may be used to load credits onto a gaming machine and cash out an award from the gaming machine. Also, the smart card may be used to store loyalty program information generated during one or more of a player's game playing activities. Further, the smart card may store prize information for a prize redeemed at a gaming machine using loyalty points accrued by the game player.

Anonymous Loyalty Credit Awards

FIG. 5 is a flow chart depicting a method of rewarding loyalty points accrued anonymously on a gaming machine. In 500, a gaming machine receives an input of some type from a game player that has not provided any identification information, such as player tracking information. The input, which may be a number of different gaming events, as described with reference to FIG. 4, such as the player depositing a indicia of credit into the gaming machine, triggers a game play session on the gaming machine where loyalty points may be accrued. In 505, a game play session is presented on the gaming machine which may include the player wagering on a number of different games of chance and game outcome presentation corresponding to each wager. For instance, the player may make 5 different wagers on 5 slot games presented on the gaming machine. In 510, a gaming event triggers the end of the game play session and an amount of loyalty points accrued during the game play session are determined. The gaming event ending the game play session may be but is not limited to 1) detecting zero credits registered on the gaming machine, 2) the gaming machine remaining idle for an amount of time, 3) detecting a tilt condition or detecting an error condition on the gaming machine, and 4) detecting a game player's request for a loyalty program instrument. A rate at which the player accrues loyalty points during the game play session may vary according to one or more of a time of day, days of a week, months of a year, an amount wagered, a game denomination, a promotional event, a game type and a rate of wagering. After the amount of loyalty points accrued during the game play session have been determined, some or all of the accrued loyalty points may be awarded to the game player. For instance, a player that does not have a loyalty program account may be awarded a higher fraction of the accrued points than a player that already has an account to encourage the player without an account to sign up for a new account.

In 515, the gaming machine may display the amount of loyalty points accrued during the game play session to one or more display screens on the gaming machine (see FIG. 4). In 517, the player may be offered the option to exchange loyalty points for a prize of some type such as goods or services. In 520, when a prize redemption is requested, a prize menu may be displayed to one or more display screens on the gaming machine. The prize menu may contain a list of prizes available and a number of loyalty points corresponding to each prize that must be redeemed to obtain each prize. In 525, a player may select a prize. In 530, when the player does not have enough loyalty points available to obtain the prize, the prize menu in 520 may be redisplayed and the player may be asked to make another selection or given an option to exit from the menu.

In one embodiment, the player may be given the option (not shown) of viewing loyalty point account information from a loyalty point account such as a player tracking account available to the player. In this case, the player may enter loyalty program account information into the gaming machine using some method. For example, the game player may insert a player tracking card into a card reader on the gaming machine and type in an identification number corresponding to the card such as a PIN number. When the card has been validated, the player may view player tracking account information. Next, to redeem a prize requiring a certain number of loyalty points, when a player does not have enough loyalty points available on the gaming machine, the player may request that loyalty points be transferred to the gaming machine from a remote loyalty point account. The gaming machine may send a request for an amount of loyalty points to a remote server. When the loyalty point transaction has been approved, the remote server may send the requested loyalty points to the gaming machine and delete the requested points from the player's account. Then, the transferred loyalty points may be added to loyalty points already available on the gaming machine and used to redeem a prize.

In 535, when a prize selection has been made and there are enough loyalty points available on the gaming machine to redeem the prize, a prize instrument may be issued to the game player. For instance, the gaming machine may print a ticket for a free meal at a restaurant. The issued ticket may be taken to a restaurant and, after the ticket has been validated, used to obtain a free meal.

In 540, after a prize redemption and points are still remaining, the player may be given the option, in 518, of updating a remote loyalty account with the remaining points. When a player does not request a prize redemption, the player may be directly presented the option to update a remote loyalty point account with some or all of the points awarded during the game play session. In 519, the player may enter loyalty program account information into the gaming machine using some method. For example, the game player may insert a player tracking card into a card reader on the gaming machine and type in an identification number corresponding to the card such as a PIN number. In 521, when the loyalty program account information has been validated by the remote server, the gaming machine may send a request to the remote server requesting that an amount of loyalty points awarded to the player be added to the player's loyalty program account.

In 545, when loyalty points remain on the gaming machine, the gaming machine may issue a loyalty point instrument storing the remaining loyalty points. For instance, the gaming machine may issue a printed ticket voucher redeemable for a certain amount of loyalty points. In 550, the gaming machine may store to a local database residing on the gaming machine loyalty program transaction information for one or more loyalty program transactions performed by the gaming machine such as but not limited to 1) loyalty point awards, 2) prize redemptions, 3) requests for loyalty program account information, 4) requests to add loyalty points to remote account, 5) requests to delete loyalty points from a remote account and 6) information regarding issued loyalty point instruments. In 550, loyalty program transaction information may also be sent to a remote server in lieu of storing the information on the gaming machine or in conjunction with storing the information on the gaming machine.

FIG. 6 is a flow chart depicting a method for validating information stored on a loyalty point instrument at a validation site connected to a cross validation network as described with reference to FIG. 3. In the embodiment shown in the figure, a loyalty point instrument is validated in a manner consistent with an EZPAY™ cashless system. In 600, a request for game service transaction information read from a loyalty point instrument is sent via a network interface on the gaming device validating the instrument to a loyalty program server. The gaming device may be a gaming machine, a casino kiosk, a hand-held wireless device or a CVT. In 605, the server identifies which gaming device owns the instrument. When a gaming device owns an instrument, the gaming device has stored information regarding the status of a particular instrument issued from a instrument generation site connected to the gaming device. As an example, as described with reference to FIG. 3, the gaming device may be a CVT connected to a number of gaming machines that generate loyalty program instruments. In 610, the server sends a request to validate the instrument to the gaming device identified as the owner of the instrument. Typically, the validation request indicates a service on the instrument has been requested. For instance, for a loyalty program ticket, a validation request may mean a request to access the loyalty points stored on the ticket has been made. For a loyalty program ticket valid for a free meal, a validation request may mean a request to obtain the meal has been made. In 615, the instrument owner receives the validation request for the instrument and marks the instrument transaction pending. While the instrument transaction is pending, any attempts to validate a loyalty program instrument with similar information is blocked by the instrument owner.

In 620, the instrument owner sends back a reply with context information to the server. As an example, the context information may be the time and place when the instrument was issued. The information from the instrument owner to the server may be sent as one or more date packets according to a communication standard shared by the instrument owner and server. In 625, after receiving the validation reply from the instrument owner, the server marks the validation request pending and sends a validation order to the gaming device validating the instrument. While the validation request is pending, the server will not allow another instrument with the same information as the instrument with the validation request pending to be validated.

In 630, the gaming device may chose to accept or reject the validation order from the server. For instance, using a security protocol, the gaming device may determine the validation order is invalid. As another example, an employee using a gaming device to validate loyalty program instruments may decide not to validate an instrument for some reason. When the gaming device accepts the validation order from the server, in 640, the gaming device sends a reply to the transaction server confirming that the transaction has been performed. The loyalty program server marks the request validated or completed which prevents another instrument with identical information from being validated. In 645, the server sends a confirmation to the instrument owner which allows the instrument owner to mark the request from pending to validated. When the gaming device rejects the validation order from the server, in 650, the gaming device sends a reply to the server to mark the validation request from pending to unvalidated. When the instrument transaction is marked unvalidated, it may be validated by another gaming device at a later time. In 655, the server sends the reply to the instrument transaction owner to mark the validation request from pending to unvalidated which allows the instrument to be validated later.

FIG. 7 is a block diagram of loyalty program systems at multiple gaming properties connected to a loyalty program transaction clearinghouse server. At least three gaming devices, a loyalty program server 310 at property 300 (described with reference to FIG. 3), a loyalty program server 710 at property 700 and one or more gaming devices along a route venue 702, may communicate with the loyalty program transaction clearing house server 341. The route may comprise a plurality of gaming machines or other devices issuing loyalty program instruments located in various venues such as stores and bars. The example is for illustrative purposes only, as many different combinations of gaming devices using different network topologies may be connected to the loyalty point instrument and prize clearinghouse 341. At property 300, one or more gaming machines, such as gaming machine 369, send loyalty program transaction information to the clerk validation terminal 360. The CVT 360 sends information to the loyalty program server 310 which may also be cashless server and data acquisition system. In this embodiment, the functions of the controller 350 and concentrator 355, as described with reference to FIG. 3, are combined into the loyalty program server 310. The loyalty point instruments used on property 300 may be smart cards, magnetic cards, ticket vouchers, room keys, debit cards, portable wireless devices and combinations thereof.

The loyalty program server 310 contains a network interface used to send information on loyalty point instruments generated on property 300 to the clearinghouse server 341 or request information 300 from the clearinghouse server 341 on loyalty point instruments issued at other properties that are being validated at property, including instruments issued at property 700 and venues along route 702. The loyalty program transaction information sent to the loyalty program server 310 from the clearinghouse server 341 and received by the clearinghouse server from the loyalty program server 310 is transmitted via the network connection 311. Further details of information transmitted between a cashless server and a cashless clearinghouse server in regards to multi-property cashless instrument validation as well as server hardware, which may be applicable to multi-property loyalty program instrument validation, are described in U.S. application Ser. No. 09/684,382 by Rowe filed Aug. 25, 2000, entitled “Cashless Transaction Clearinghouse.”

At property 700 gaming machines, such as gaming machine 769, and other gaming devices located at other venues 738, such as a loyalty point instrument generation site at a pit game, are connected to the loyalty program server and data acquisition system 710 via the local network 712. The local network 712 may be a wireless or wired connection system including fiber, copper or wireless cellular, combinations of all three or other connection systems. A separate CVT is not shown in this embodiment. The functions of the CVT including storage of loyalty program transaction information may be built into one or more the gaming machines including 769 or may be built into the loyalty program server 710. The information sent to the loyalty program server 710 from the clearinghouse server 341 and received by the clearing house server 341 from the loyalty program server 710 is transmitted via the network connection 71 1. Along the route venue 702, one or more gaming machine and other gaming devices located in a plurality of properties send and receive loyalty program transaction information for the clearinghouse 341 via Internet connection 712.

Components of the transaction clearinghouse server 341 may include 1) a memory storage unit for storing loyalty program transaction information in a transaction database, 2) a functional router enabling communication between the clearinghouse server and different properties, 3) a logic devices such as one or microprocessors, 4) a memory containing software for implementing the clearinghouse functions and 5) a network interface. The transaction database may contain on-going and past loyalty point instrument transactions processed using the clearinghouse server. The transaction database may be implemented using Microsoft NT (Microsoft, Redmond, Wash.) and SQL (server query language). The loyalty program servers, including 310 and 710, may also utilize this database technology.

Loyalty program instrument transaction information for two or more gaming properties may be stored in the clearinghouse server transaction database. The properties may be owned by the same or different gaming establishments. The transaction database may be accessed remotely by the properties, including 300 and 700, utilizing the clearinghouse server 341. Further, the transaction database may be used with analysis software to analyze transactions routed through the clearinghouse server 341.

The requirements associated with accounting and reporting of the loyalty program instrument information may be dependent on the regulations within a particular gaming jurisdiction. That being the case, the system is adaptable to those particular regulations. In general, a loyalty program instrument with an award amount may be considered to be analogous to a personal check written by the property where it was generated. When the loyalty program instrument is validated, it is essentially cashed. This implies that the property where the cashless instrument was generated must maintain a database of data related to those loyalty program instruments that were created on its property. This is analogous to maintaining a bank account whose sole purpose is to cover the loyalty program instruments that were generated at the property. This property is usually responsible for maintaining its loyalty program instrument database and validating loyalty program instruments. When a request to validate a loyalty program instrument is received by the loyalty program system at a particular gaming property, the property has the option of validating or rejecting the request. Once the property validates the loyalty program instrument, it is typically the responsibility of that property to insure its own loyalty program instrument transaction database is updated. At that time, the property that generated the loyalty program instrument may transfer the funds to the property requesting the validation. The fund transfers may occur with each transaction or could be compiled in a batch to cover multiple instrument validation transactions on a periodic basis (e.g., once a night). The transaction clearinghouse may facilitate all associated electronic fuind transfers (EFTs) and acts as a third party between the parties.

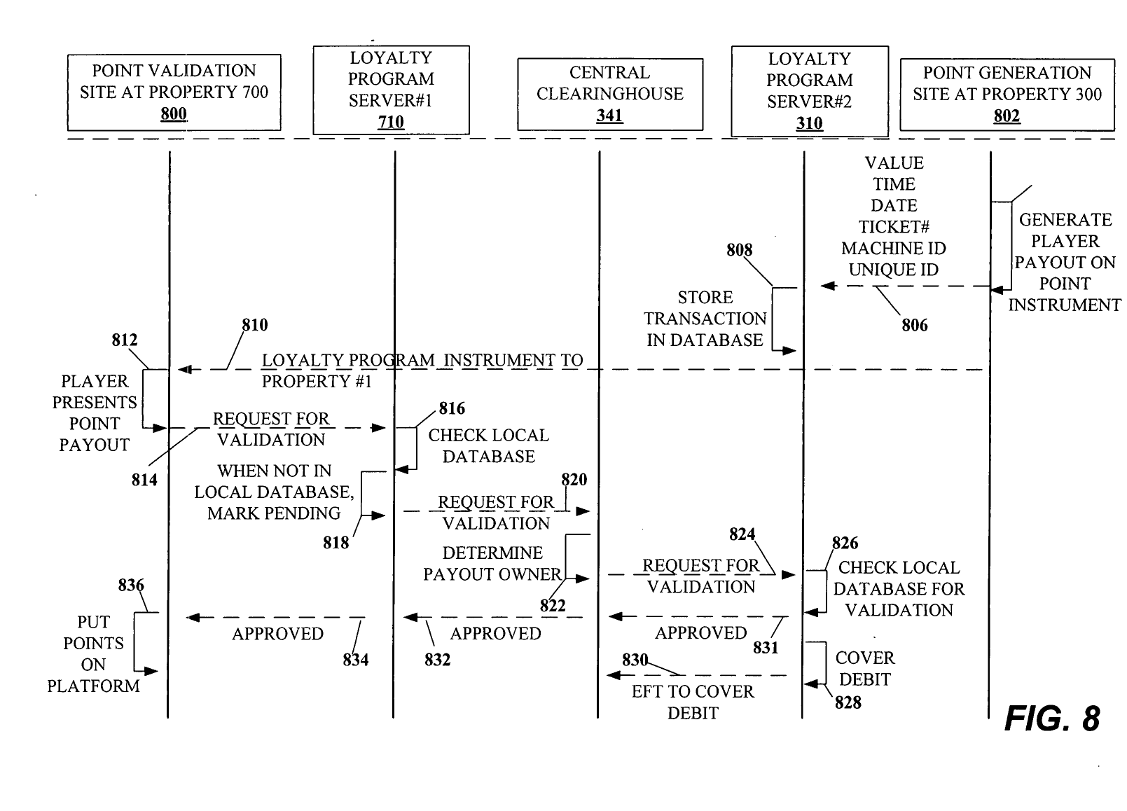

FIG. 8 is an interaction diagram for a loyalty program instrument transaction between a clearinghouse, loyalty program servers, and loyalty program instrument generators/validators where the loyalty program instrument is generated at a different location from where it is validated. In 804, awarded loyalty points are generated on a loyalty program instrument at a loyalty program instrument generation site 802 at property 300. The loyalty program generation site may include but is not limited to a gaming machine, a clerk validation terminal, a wireless validation terminal, a casino kiosk and a cashier station. The loyalty program instrument may include a printed ticket voucher (e.g. EZPAY™ ticket), a smart card, a debit card, a room key and a portable wireless device. In 806, when the loyalty program instrument is generated, loyalty program transaction information, including but not limited to 1) a value, 2) an issue date, 3) an issue time, 4) a transaction number unique to the transaction, 5) a machine ID that generated the loyalty program instrument, 6) an issue location and 7) an instrument sequence number, may be transmitted to the loyalty program server 310. The loyalty program instrument transaction information is also stored on the loyalty program instrument when the loyalty program instrument is generated in 804. In 808, the loyalty program server 310 may store the loyalty program instrument transaction information in a database. The transaction information stored in the database is used when the loyalty program instrument is validated. The validation process may be invoked when the loyalty program instrument is redeemed for a prize or when the loyalty program instrument is used in a gaming machine or other device that accepts the loyalty program instrument. The validation process involves comparing the loyalty program instrument transaction information stored on the loyalty program instrument with the loyalty program instrument transaction information stored in the loyalty program server database.

In 810, a game player takes the loyalty program instrument generated at property 300 to property 700. In 812, the game player presents the loyalty program instrument for a prize redemption at a loyalty program transaction validation site 800 at property 700. The loyalty program transaction validation site may include a gaming machine, a cashier station, a clerk validation terminal, a wireless validation device and any other devices that accept loyalty program instruments. For instance, when a debit card is used as the loyalty program instrument, the game player may be able to directly deposit the awarded loyalty points on the debit card into a loyalty program account, such as a player tracking account, accessible to the game player. In 814, a validation request is sent from the loyalty program transaction validation site 800 to the loyalty program server 710. The validation request may be an information packet containing the transaction information stored on the loyalty program instrument in 804 and stored in the loyalty program server database in 808.

In 816, the loyalty program server 710 may check the local loyalty program transaction database on the loyalty program server 710 to determine if the loyalty program instrument was generated at property 300. The loyalty program server may check the local loyalty program transaction database in a number of ways to determine whether a transaction record for the loyalty program instrument resides in the database. The database search technique may depend on what information is stored in the local database and what information is stored on the loyalty program instrument. When the loyalty program instrument was generated at a property using a different loyalty program system than the property where the loyalty program instrument is validated, the type and amount of loyalty program instrument transaction information stored on the loyalty program instrument may differ from the type and amount of loyalty program transaction information stored on the local loyalty program transaction instrument database. Thus, the search technique may depend on determining a common set of transaction information stored on the loyalty program instrument being validated and stored in the loyalty program transaction database. For instance, when the loyalty program instrument contains a machine ID and the loyalty program transaction database stores a list of all the local machine IDs, the loyalty program server 710 may search the local loyalty program transaction database to determine whether the loyalty program instrument was generated on one of the local machines at the property 700. As another example, when the loyalty program instrument contains transaction information on the property where the loyalty program instrument was generated or the owner of the loyalty program instrument (e.g., the owner of the property), the loyalty program server 710 may quickly determine whether the loyalty program instrument was generated at the local property 700.

In 818, when the loyalty program instrument was not generated locally, the loyalty program server 710 may mark the validation request pending in a local database and send a request for validation to the central clearinghouse 341 in 820. The request for validation from the loyalty program server 710 to the loyalty program instrument transaction clearinghouse 341 may contain all or some subset of the information stored on the loyalty program instrument being validated. In addition, the request for validation may contain information about the loyalty program transaction validation site. For example, the identification information about the loyalty program transaction validation site 800, the property 700 where the loyalty program transaction validation site is being validated and the owner of the may be included in the request for validation message.

As in 814, the request for validation in 820 may be an information packet of some type sent using a pre-determined communication protocol between the loyalty program server 710 and the central clearinghouse 341. The communication protocol used to transmit transaction information between the loyalty program transaction validation site 800 and the loyalty program server 710 in 814 may be the same or different than the communication protocol used to transmit the transaction information between the loyalty program server 710 and the loyalty program instrument transaction clearinghouse 341 in 820.

In 822, the loyalty program transaction clearinghouse determines the owner of the loyalty program instrument (e.g., the property where the loyalty program instrument was generated). The clearinghouse 341 determines the owner based upon information received in the validation request in 820 and based upon information stored in the clearinghouse 341. In 824, using routing information stored within the clearinghouse 341, a request for validation is sent from the clearinghouse 341 to the property where the loyalty program instrument was generated (i.e., property 300 in this embodiment). The request for validation is an information packet in a communication protocol of some type. The transaction information contained within the information packet is sufficient to allow the loyalty program server 310 at the loyalty program generation site 802 at property 300 to validate the loyalty program instrument. The communication protocol used to transmit the transaction information between the loyalty program server 310 and the clearinghouse 341 in 820 may be the same or different than the communication protocol used to transmit the transaction information between the loyalty program instrument transaction clearinghouse 341 and the loyalty program server 710 in 824. For example, the communication protocols may be different when the loyalty program system used at property 700 is different from the loyalty program system used at property 300.

In 826, the loyalty program server 300 checks the local loyalty program instrument transaction database to confirm the request for validation received in 824 is valid. When the transaction is valid (e.g., the loyalty program instrument was generated at property 300 and has not been previously validated), in 831, an approval message may be sent from the loyalty program server 310 to the clearinghouse 341, in 832, the clearinghouse may forward or generate the approval message to the loyalty program sever 710, in 834, the loyalty program server 310 may forward or generate the approval message to the loyalty program transaction validation site 800. In 828, the loyalty program server may represent the transaction as a debit and cover the debit by allocating or transferring funds to an account used to cover debits. For example, each loyalty point may be assigned a pre-determined value such as a $0.01 US dollars. In 830, the loyalty program server 3 10 may send an Electronic Fund Transfer (EFT) to cover the debit to the clearinghouse 341. The EFT may be sent after each transfer or may be sent as a batch at the end of some time period, e.g. at the end of each day.

In 836, the validation site 800 at property 700, performs an appropriate operation when the validation is approved. For example, when the validation site 800 is a gaming machine, loyalty points may be posted on the gaming machine. As another example, when the validation site 800 is a cashier station, the player may receive a prize according to the value of the loyalty program instrument.

All Expenditures Tracking and Rewards

Continuing further, yet another embodiment of the present invention involves the comprehensive tracking and rewarding of all expenditures of patrons with respect to the gaming establishment. This includes not only expenditures associated with gaming activities and player wagers, but also all other purchases within and about the gaming establishment, including purchases involving the procurement of food, lodging, entertainment, transportation, merchandise, services and other similar items. By tracking and collecting data on all expenditures of a patron, a more precise estimate of the value of that patron to the establishment can be calculated, since the ratio of gaming activities to other purchasing activities can vary significantly from patron to patron. Loyalty credits can then be awarded to patrons based upon all or substantially all expenditures and not just gaming activities. In addition, detailed expenditures data can be analyzed together with overall estimated patron values in order to provide patrons with customized comps tailored to patron preferences that will increase patron satisfaction and loyalty.

As will be readily appreciated, some or all of the instrumentalities and devices of the foregoing embodiments may be used in such a comprehensive all expenditures tracking and loyalty credit system. Of course, the gaming activities aspects can be tracked and loyalty credits can be awarded on existing player tracking systems having established loyalty instruments such as cards and printed tickets, established loyalty credit generation gaming sites configured to generate and issue primary amounts of loyalty credits to patrons based upon their gaming activities (e.g., player tracking units), and established loyalty program servers configured to store loyalty credit system information and administer loyalty credit programs. Various examples, configurations and networks of such instruments, sites and servers are provided above, and it is specifically contemplated that all such examples and many other alternatives of such may be used to construct and operate a comprehensive an all expenditures tracking and rewards system embodiment, as will be readily appreciated.

In addition, one or more loyalty credit generation purchasing sites can be added, with such purchasing sites being configured to generate and issue secondary amounts of loyalty credits to patrons based upon their purchasing activities. Such loyalty credit generation purchasing sites can be identical or substantially similar to existing player tracking units, with adaptations as needed or desired to make such units compatible with other purchasing site equipment, such as cash registers, front desk systems and terminals, and other casino network and retail devices. For example, platform software may be implemented such that cash registers and other financial network devices can communicate with a conventional player tracking unit installed at a gift shop or restaurant. Information such as purchase amounts, item identifications, item margins, overall margins, set loyalty credits to be awarded per item, purchase amount, or margin level, and other data may be communicated between devices as desired within a given system.

Achieving system compatibility or interoperability can be accomplished through any number of platforms, means and techniques known in the computing arts, and details of the precise means and methods used to implement such system compatibility are not of particular importance. In fact, it is contemplated that any and all such ways of achieving a suitable level of system interoperability can be used in conjunction with the present invention. For example, a communication buffer or layer such as an application program interface (API) can be established between disparate systems or components to facilitate communication and the exchange of information. Multiple APIs can be used as necessary where many disparate systems and components exist, and such APIs can be selected from those that are commercially available, those that are custom designed for particular applications, or both, the implementation of any of which will be readily appreciated by those skilled in the art.

Alternatively, specially designed expenditure tracking and loyalty credit awarding devices may be implemented at purchasing sites, with such specially designed and implemented devices also being configured to generate and issue loyalty credits based on purchasing activities at the purchasing sites. In any event, either form of device is configured to issue secondary amounts of loyalty credits corresponding to purchasing activities at the purchasing site. It will be readily appreciated that while such loyalty credits have been termed “secondary,” that these loyalty credits can be identical or equivalent to the “primary” amounts of loyalty credits that are issued based upon gaming activities at loyalty credit generation gaming sites. Because it may be desirable for a gaming operator to know whether a given patron accrues most of his or her loyalty credits via gaming activities or purchasing activities, the designation of primary and secondary amounts of loyalty credits can be appropriate in some instances. It is preferable that these credits be of the same unit or denomination, however, such that patrons are allowed to commingle or otherwise combine primary and secondary loyalty credits for status and rewards purposes. In fact, it may be desirable that patrons not be made aware of any distinction between the types of loyalty credits, and such distinctions may not even be kept by a gaming establishment in any event.

As in the case of player tracking units adapted to issue and award loyalty credits in conjunction with gaming activities, such units adapted to issue and award loyalty credits in conjunction with purchasing activities are preferably placed in communication with a loyalty credit program network including at least one server. Alternatively, either form of player tracking and loyalty credit issuing units can be adapted to operate in isolation by recording loyalty credit awards and other patron tracking information onto loyalty instruments such as cards or printed tickets. The later redemption or conversion of such loyalty instruments may then involve the recovery of information into the loyalty program system and the reconciliation of issued loyalty credits to patrons.

Another adaptation to the foregoing instrumentalities and devices that may be required for such a comprehensive all expenditures tracking and rewards system involves the use of new loyalty instruments or the upgrading of existing loyalty instruments such that they are adapted to facilitate the tracking and commingling of primary amounts of loyalty credits attributable to gaming activities and secondary amounts of loyalty credits attributable to purchasing activities. Such an adaptation can be relatively simple where similar player tracking and loyalty credit issuing units are provided at purchasing locations such as gift shops, restaurants, front desks, concierge desks and the like. In such cases, existing player tracking cards and existing printed ticket systems can be used, with the actual loyalty instruments themselves not being able to distinguish between one form of loyalty credits or another. Indeed, as noted above, it may be preferable for a player tracking card or patron loyalty account to not be able to tell where its stored credits came from. That is, rather than storing 2000 gaming activity generated loyalty credits and 3000 purchasing activity generated loyalty credits on a loyalty instrument or in a loyalty account as such, only 5000 loyalty credits would be stored. Information as to where different amounts of credits were awarded can be tracked and dealt with separately within the system.

One other adaptation to the foregoing instrumentalities and devices involves the use of new or upgraded loyalty program servers configured to store loyalty credit system information and administer loyalty programs. In addition to the standard functions provided by such servers, as discussed in greater detail above, these servers are also preferably able to establish or at least process theoretical all expenditures profiles for patrons based upon their gaming and purchasing activities, and to make recommendations to gaming establishment personnel regarding awards of customized comps to patrons based upon their theoretical all expenditures profiles. Such upgrades can be made to existing servers by simply providing additional software or system programs adapted to provide these new functionalities.

In this manner, a comprehensive loyalty program can be established that awards patrons loyalty credits for every aspect of their visit or stay at a gaming establishment. Of course, these loyalty credits can be constructed into many different types and formats, such as player tracking points, comp points, other forms of points, or simply cash or cash equivalent credits, for example. Also, a gaming establishment can comprise many different things, such as a single casino or gaming operator, a set of commonly owned gaming properties, or an affiliated group of gaming properties and purchasing establishments, such as shops, restaurants, arenas and travel agencies, for example. Loyalty credits can be awarded for substantially all expenditures a patron has at the establishment, such as for gaming activities and purchasing activities involving the procurement of, for example, food, lodging, entertainment, transportation, merchandise or services, among others items. Loyalty credits may also be awarded for other activities or functions as desired, such as on various promotional bases for special events, activities or membership sign ups.

In addition, the rate at which patrons receive loyalty credits may be varied based on numerous factors, such as the category of spending, the time or location of spending, and the amount of spending, among others. In particular, the category of spending may prove to be a critical factor, as some items have different margins than others within the hotel, restaurant, entertainment, service and retail industries. For example, fewer loyalty credits might be awarded per dollar spent on discount hotel rooms than for premium entertainment tickets, which typically have a higher margin for the provider. It is specifically contemplated that loyalty credits for purchasing activities be tied more to margin than to actual dollars spent by a patron, as it may prove to be inefficient to award large amounts of loyalty credits for discounted items such as promotional room rates and buffets. Conversely, greater amounts of loyalty credits per dollar spent could be granted for many types of full retail purchases.

Other such examples of loyalty credit awards and variances for such are also provided above. As noted above, special bonus credit promotions such as double or triple loyalty credit awards and the like may be created for special promotions or promotional periods, for both low and high activity rate times. Typical low activity bonus award instances could include weekdays, after midnight, or during off-season periods, while peak gaming activity periods could include summer weekends or premium sporting events, such as a boxing match at the gaming property or an affiliate, for example. Other ways to vary the amounts of loyalty credits awarded may also be used, as desired. With such wide varieties in award sources and ways to award loyalty credits being created or augmented, it is thought that a larger or more significant loyalty credit program authority, moderator or program administrator might also be useful. Such an administrator could aid in establishing award schedules for different sources and types of purchasing, and would have the authority to approve or disallow special promotions or variances that would venture outside the limits of such a schedule or set of guidelines. The use of such a program administrator could also aid in the tracking and analysis of player spending patterns and other such information.

Accordingly, it is also contemplated that player specific databases be used to track and record such information, in addition to recording player loyalty credit account balances and other related data. Such databases can be local within each gaming property, although it is preferred that at least one central database exist, such that any gaming property, affiliate or managing entity can have access to pooled and analyzed data in such a central database. Such information may include details on, for example, the locations that a patron spends money, rates of spending, types of items and specific items purchased, prices and discounts or promotions involved in any and all purchases, and spending habits or trends, among others.

It will be appreciated that use of the terms spending and purchases in this context is as broad as possible, and that such use includes all gaming activities and all purchasing activities where a patron might place any bet or wager or might make any expenditure whatsoever. Data for all such instances can be tracked per item, and combined in meaningful ways in order to gain a better understanding of each patron individually and groups of patrons in general. Patrons can be categorized into groups, areas or levels based on certain purchases, spending habits and gaming habits. Of course, such categorizations or placements of patrons need not be permanent, and such classifications can be changed as more information is gained or as it becomes apparent that a given patron has changed his or her spending patterns over time. In addition, it is specifically contemplated that such patron databases be closely linked with the server or servers running the player tracking and patron loyalty credits programs, such that information stored and analyzed on each patron can be used to provide better and more customized comps and service provided to that patron as well as to inform the gaming establishment of the spending patterns and habits of the patron, various aspects of which are discussed in greater detail below.

Other contemplated abilities of an improved or updated server or set of servers under this particular embodiment include those for the auditing, reconciliation, tracking and accounting of all types of information on the player tracking and/or loyalty credit program server or servers themselves. Such servers can record not only patron loyalty credits and other patron information, but also track redemption and reconciliation of claimed and outstanding comps and comp offers. In addition, tax and regulatory related issues and information, such as those relating to the issuance, tracking and redemption of comps and comp offers can be provided for on these servers, with information, calculations, adjustments and/or payments for items such as taxes, credits, redeemed values, outstanding values, expired items and the like all being accounted for in such a system.

Of course, such a comprehensive server or set of servers can be central to a network of affiliated gaming properties, purchasing properties and/or entities, which may form a “gaming establishment” as discussed above. Such a network or group of properties may utilize a single patron database and/or a set of distributed or individual databases, and it is preferable that all patron activities and expenditures across many or all such affiliated or grouped properties be tracked and awarded. To this extent, a universal loyalty instrument that can be used across many or all affiliated properties and units be issued to patrons. As in the foregoing examples, such a loyalty instrument can be a smart card, a debit card, a magnetic striped card, a printed ticket, a room key, a portable wireless device, or any other device or item that can be conveniently assigned to a patron and used to facilitate the tracking of activities and expenditures and the awarding of loyalty credits across many or all locations. Of course, other types of loyalty instruments can be implemented if desired, and it will be understood that all such implementations, can be used in conjunction with the present invention.

As also noted previously, one preferable feature of the present embodiment involves the use of the comprehensive server or set of servers and patron database or databases, among other elements of the system, to track individual patron gaming and spending habits. Such information can then be used to determine specific comps, bonuses and other awards that are more tailored toward the preferences of each patron. Information can be gleaned from individual purchases and gaming events, groups of purchases and gaming events, personal items within the profile of a patron, the use and redemption or non-redemption of past comps, bonuses and offers, and feedback from the patron. In this regard, it is preferable that patrons be asked for or provided with an avenue to give feedback regarding the loyalty program. Input from patrons as to why they did or did not use a given comp can be considered in granting the same or similar comps or rewards to that patron in the future. For example, an unredeemed comp may be due to a patron not liking what was offered, or simply because the patron was not able to accept the offer for some other unique or transient reason. In the case of the former instance, that comp should not be offered again, while the comp should be offered at some later time in the case of the latter instance.

Another preferable feature of this embodiment involves the ability to use specific tracked and recorded data for patrons to provide dynamic bonuses and comps as the patron proceeds through the property participating in gaming activities and/or making purchases. As noted above, such data can be used to tailor comps and awards to patrons so that patrons will generally obtain more satisfaction from what is being offered to them individually. Additionally, such comps, bonuses and awards can be made on the spot by the gaming establishment, without any input or request from patrons for the particular comps or bonuses provided. For example, a given purchase at a gift shop may raise a particular patron above a threshold for either total spending, total margin to the establishment, rate of spending within a set time period, or some other parameter, such that a new and unrequested comp can be provided to the patron by personnel at the gift shop. Because the system is adapted to facilitate the tracking, recording and analysis of specific patron spending habits and patterns, an actual recommendation for a specific comp can be made by the system on the spot. Such dynamic and unrequested comps should increase the greater overall satisfaction of patrons, as they perceive that their individual values and worth to the establishment are being compensated in a manner that is tailored to their needs and preferences.

To this end, a “theoretical all expenditures profile” can be established and updated for any given patron or group of patrons. Preferably, such a profile will attach individually to each patron recorded in the system, such that the gaming establishment can create, track and update the profile for every patron according to their past and ongoing activities within the system. Such a theoretical all expenditures profile can be calculated in any of a wide variety of ways, any of which preferably point to an overall value assigned to that patron with respect to the establishment. This overall value can be expressed in a number of ways, any of which preferably relate to an expected level or amount of income to the gaming establishment resulting from all expenditures of the patron across all aspects of the gaming establishment. Thus, while a “theoretical win profile” presumably expresses an overall patron value to the gaming establishment that is related to only the gaming activities of a patron, a theoretical all expenditures profile expresses an overall patron value to the gaming establishment that is related to all expenditures of a patron, including both gaming activities and purchasing activities.

It will be readily appreciated that the actual number, value or index of such a theoretical win profile can vary as desired and as definitions and relative values of different spending categories vary from establishment to establishment. For example, one establishment may wish to provide a concrete number that is tied strictly to the bottom line for an individual patron in isolation, and thus its use of a theoretical win profile is a single number value assigned to a patron that represents the expected net income to the establishment for that patron only for any given hour or day spent at the establishment. In such an instance, heavy emphasis will likely be placed on the net expected returns from that patron only during his or her gaming activities, and the margin values on the typical or expected purchases made by that patron only during an ordinary visit. On the other hand, another establishment may decide to place more emphasis on volumes of purchases as opposed to strict margins, and may decide to reward various categories of spending differently, such that spending in some categories is weighted more than others in creating and updating the theoretical all expenditures profiles of patrons.

Furthermore, some establishments may allow for the addition of other factors that are not derived directly from the gaming and spending activities of a given patron in calculating a profile, but that nevertheless reflect the value of that patron to the establishment. For example, consideration may be given to the effect that a magnanimous patron can have on a given gaming environment, such as a craps table. For example, while a particular patron may not lose much money himself at a craps game, an establishment may notice a trend of that patron always or usually causing a lot of excitement and frenzied betting activity when he plays craps, with the result being more overall profit to the establishment. Similarly, prolific spenders can tend to entice others to also spend more than they normally would, with an overall benefit to the establishment being realized not only by the purchases of the spender himself, but also by the effect that the spender has on others to spend more. In addition, celebrities and other popular people generally attract others to a venue simply by their presence at the venue. Such patrons may have their theoretical all expenditures profiles factored upwards for such effects on others, as desired by a given gaming establishment.

As noted above, the actual factors, input and calculations used to arrive at a theoretical all expenditures profile can vary, and there are a vast number of ways to construct and arrive at such a profile. In general, this term represents the expected value of a patron to the gaming establishment in terms of the income that the establishment can expect to generate from that patron. This income presumably is derived from at least the expenditures of the patron, and other factors may be added as desired. The term “all expenditures” is used to better reflect that gaming activities and other spending activities are used to calculate this profile. A wide variety of formulae and factors for such may adopted, and it is specifically contemplated that any such formula or means for deriving a profile value or array of values may be appropriate for a given casino or institution. Various statistical devices such as, for example, sums, products, averages, weighted averages, standard deviations, weighted deviations, normalizations, distributions, and other such items may be used in creating a statistical formula or process for such a theoretical all expenditures profile.

In one very basic example, a simple summation can be made of the net loss of a patron from all gaming activities during a given visit and the combined margins or net returns to the casino from all purchasing activities by that patron during that visit to arrive at an actual number that is the theoretical all expenditures profile for that patron, which number represents the approximate net return that the casino can expect from that patron per visit. In this instance, the formula that would be used to calculate this theoretical all expenditures profile could be expressed as:
TAEP_{P}=ΣGA+ΣPM
where TAEP represents a single theoretical all expenditures profile value for patron P in terms of expected generated income per visit, ΣGA represents the summed net total of all gaming activity for the patron during his or her visit, and ΣPM represents the summed total of all margins on purchases made by the patron during his or her visit. Upon subsequent visits, this value could be calculated again per visit and then averaged based on past calculations of the value. Under such a basic averaging method, the formula could then be represented as:
TAEP_{P}=[(ΣGA+ΣPM)₁+(ΣGA+ΣPM)₂+ . . . (ΣGA+ΣPM)_{N}]/N
where N represents the total number of visits to the gaming establishment by patron P, and each (ΣGA+ΣPM)ₙ figure in the calculation represents the sum of all gaming activity and all margins on purchases by patron P during a given “n” visit.

Of course, it is likely that a gaming establishment will want to add other factors and details into such a calculation, such that this formula will become more complex in any given application. Factors for length of visit, duration of gaming activities, duration of spending activities, weightings for same, standard deviations of the wins and losses for the patron during gaming activities, and breakdowns of wins and losses per type of gaming activity are some examples of other factors and details that can be added to this formula to help predict more accurately the expected income to be derived from a given patron. It may be desirable that such a value or set of values be expressed on a per day or per hour basis rather than a per visit basis, especially where some patrons frequent the gaming establishment often, but only for an hour or two at some times, and for many hours or overnight at other times, such as in the case of locals, for example. In such instances, it may be better to derive a theoretical all expenditures profile on a per hour basis.

In the event that many factors are added to such a calculation, one example of a formula that could be used for calculating a theoretical all expenditures profile is the following:
TAEP_{PH}=[ΣTGA_{P}+ΣGMA_{P}+ΣOGA_{P}+ΣAGA_{OP}+ΣPM_{P}+ΣPM_{OP}+ΣOM_{P}]/H
where TAEP_{PH} is the theoretical all expenditures profile value for patron P in terms of expected generated income per hour within the establishment, ΣTGA_{P} represents the summed net total of all prior table gaming activity for the patron at the establishment, ΣGMA_{P} represents the summed net total of all prior gaming machine activity for the patron at the establishment, ΣOGA_{P} represents the summed net total of all prior other gaming activity for the patron at the establishment, ΣAGA_{OP} represents the summed net total of all prior gaming activity attributed to other players due to patron P playing, purchasing or being at the establishment, ΣPM_{P} represents the summed total of all margins on all purchases made by the patron at the establishment, ΣPM_{OP} represents the summed total of all margins on all purchases made by other players due to patron P playing, purchasing or being at the establishment, ΣOM_{P} represents the summed total of all other margins, credits or other benefits that can be attributed to patron P due to his or her activities and presence at the establishment, and H represents the total number of hours that patron P has ever spent at the establishment. Weighting factors that weigh past activities toward the most recent events might also be implemented.

Of course, this value can be a dynamic value, and can be calculated whenever patron P returns or is at the establishment. It will be readily appreciated as well that many other factors and formulae can be used, and that many other calculation techniques and weighting preferences can be used by different gaming establishments depending upon the varying aims and business objectives of such establishments. It is specifically contemplated that no one way of calculating or formulating such a profile is perfect, and that the foregoing is just one example of a virtually infinite number of ways of arriving at such a profile. Of course, it will also be readily appreciated that a given gaming “establishment” as used herein can include one, some, or all properties or establishments within or associated with a given network or system.

In addition, it is contemplated that the calculation or updating of a given theoretical all expenditures profile can be done periodically or incrementally, such as at the end of a visit, day, or hour, or can be done dynamically as expenditures occur. Where processing power allows, dynamic updating may be more preferable, since an up to the second profile for a given patron may prove more valuable to the gaming establishment both in having such information readily available to personnel if desired and in having such information available to the system for use in analyzing history and status and being able to provide tailored comps dynamically as they are merited. For example, when a profile is only updated or recalculated daily, dynamic comps that may be merited during a particularly active day by a patron would likely not be awarded until at least the next day in many cases. Conversely, an up to the second updated profile might result in the awarding of a dynamic comp after the very purchase or gaming event that thrusts a patron past a particular spending or loyalty credit threshold.

Thus, while prior art systems and methods for player tracking and rewards focus on tracking and rewarding only gaming related activities of patrons, the inventive systems and methods disclosed herein provide for the tracking and rewarding of all patron expenditures within a gaming establishment, such that more data and pertinent information on patrons is tracked and recorded, and patrons are provided with greater rewards based on all of their spending within an establishment. Under such systems, patrons that previously did not participate in much gaming are now rewarded and comped based upon their overall expenditures within and about a gaming property according to their overall value to the gaming property, whereas such patrons may never have been rewarded or comped previously. Of course, high rollers who do participate in many gaming activities and also stay in luxury suites, order fine cuisine and purchase expensive merchandise are rewarded even further than they ordinarily would be under prior art systems that rewarded only for gaming activities.

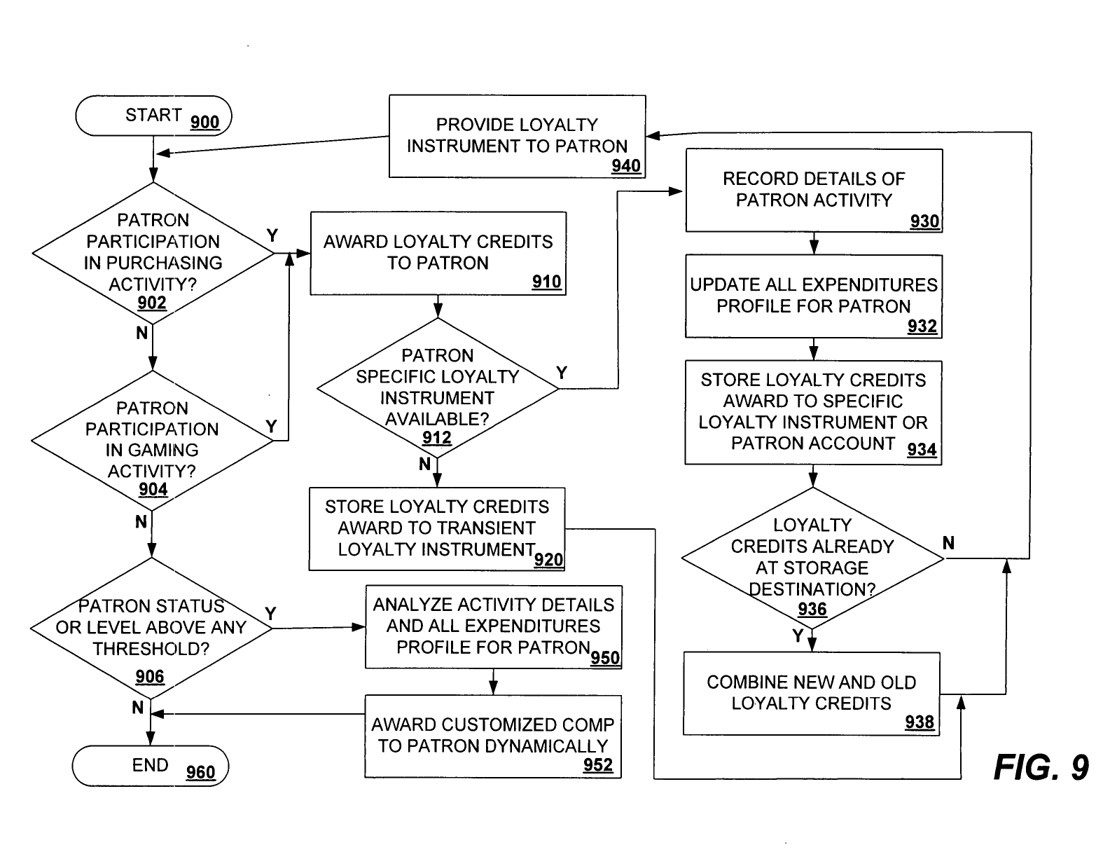

FIG. 9 is a flow chart depicting a comprehensive method of differentiating patrons and awarding loyalty credits to patrons of a gaming establishment based upon the overall value of the patrons to the gaming establishment according to the foregoing embodiments. It will be readily appreciated that not every element and step within this flow chart is necessary, and that in fact it may be preferable to practice embodiments that only embrace portions of this illustrated process and omit others. After an initial start step 900, an inquiry is made at a decision step 902 as to whether a patron has participated in a purchasing activity for which loyalty credits are awarded. If the answer is no, then the process moves to a following decision step 904, where an inquiry is made as to whether a patron has participated in a gaming activity for which loyalty credits are awarded. If the answer to this inquiry is no, then the process moves to a subsequent decision step 906, which is discussed further below. If the answer to the inquiry of either of decision steps 902 or 904 is yes, however, then the method continues to process step 910, where loyalty credits are awarded to the patron based upon the level of purchasing or gaming activity. After this process step, an inquiry is made as to whether a patron specific loyalty instrument is available at a following decision step 912. If the answer is no, then the awarded loyalty credits are stored on a transient loyalty instrument, such as a printed ticket at a process step 920, and the method then continues to a process step 940, where the ticket or other such transient loyalty instrument is provided to the patron.

If the answer to decision step 912 is yes, however, such as in the case of the patron providing a player tracking card or other universal loyalty instrument, then the process moves to a process step 930. At step 930, the details of the specific patron activity are recorded, preferably in a record that identifies or is related in some way to the known patron. In a preferred embodiment, this recordation is made in some file or sub-file that is either within the patron account for that patron on the server, or at least points to or from this patron account. The method then continues to a process step 932, where the all expenditures profile for the known patron is updated to reflect the specific patron activity that just occurred. At a subsequent process step 934, the awarded loyalty credits are stored to a patron account, such as on a server, or on the provided patron specific loyalty instrument, such as a player tracking card. As a side note, it will be readily appreciated that the order of steps 930, 932, and 934 is not of particular importance, and that any other order for these steps should work equally well.

At decision step 936, an inquiry is made as to whether loyalty credits are already stored at the storage destination (e.g., a patron account on the server or a player tracking card). If the answer is yes and credits already exist for that patron at the storage location, then the old credits are combined with the new credits at a following process step 938, after which the method continues to process step 940. If the answer is no, then the method simply continues to process step 940. Of course, it is also possible that this decision step 936 precede storage step 934, and that steps 934 and 938 be combined into one step in some cases, with a separate storage step existing after a “no” answer to decision step 936. At process step 940, the loyalty instrument is given or returned to the patron, and the method then reverts to decision step 902.

In the event that the answer is no to decision steps 902 and 904, the process then continues to decision step 906, where an inquiry is made as to whether the patron status or level has exceeded any particular threshold in any category. If the answer to this question is also no, then the process ends at an end step 960, where it is understood that the process could begin again at any time whenever patron activity occurs again. If the answer to the inquiry is yes, however, then the method moves on to a process step 950, where the specific activity details of the patron that are on file and the current theoretical all expenditures profile for the patron on file are analyzed to determine an appropriate level and type of customized dynamic comp to be awarded. At the next process step 952, a customized comp is then awarded to the patron dynamically based on this analysis from step 950. This is preferably done without any request or further input from the patron. The process then ends at end step 960, where it is again understood that the process could begin again for new patron activity.

Although the foregoing invention has been described in detail by way of illustration and example for purposes of clarity and understanding, it will be recognized that the above described invention may be embodied in many other specific variations and embodiments without departing from the spirit or essential characteristics of the invention. For instance, while the exemplary gaming machines of this invention have been shown as having top boxes mounted atop the main gaming machine cabinets, use of such gaming devices is not so limited. Gaming machines without a top box could also be used with this invention, for example. Other similar changes and modifications may be practiced, and it is understood that the invention is not to be limited by the foregoing details, but rather is to be defined by the scope of the appended claims.

1. A method of awarding loyalty credits to patrons of a gaming establishment providing a loyalty credits program, the method comprising:
providing a first loyalty instrument, said first loyalty instrument being adapted to facilitate the tracking of an amount of loyalty credits attributable to a patron of said gaming establishment;
determining that said patron has begun a gaming activity for which loyalty credits are awarded, said gaming activity involving the placement of a wager by said patron, the play of a game, and the possibility of a monetary award to said patron based upon the outcome of said game;
awarding said patron a first amount of loyalty credits corresponding to the participation of said patron in said gaming activity;
storing said first amount of loyalty credits into an account assigned to said patron or onto said first loyalty instrument;
determining that said patron has made a purchase for which loyalty credits are awarded, said purchase involving the procurement of food, lodging, entertainment, transportation, merchandise or services;
awarding said patron a second amount of loyalty credits corresponding to said purchase, wherein said second amount of loyalty credits are in the same units as said first amount of loyalty credits;
combining said first amount of loyalty credits and said second amount of loyalty credits into a combined amount of loyalty credits; and
storing said combined amount of loyalty credits into an account assigned to said patron or onto a combined loyalty instrument, said combined loyalty instrument being adapted for tracking an amount of loyalty credits attributable to said patron,
wherein said gaming establishment is the sole entity providing said loyalty credits program and wherein said gaming establishment controls or authorizes the administration, distribution and redemption of substantially all of said loyalty credits and loyalty instruments.

2. The method of claim 1, wherein said step of providing a first loyalty instrument includes providing said first loyalty instrument to said patron.

3. The method of claim 1, wherein said combined loyalty instrument is selected from the group consisting of a smart card, a debit card, a magnetic striped card, a printed ticket, a room key and a portable wireless device.

4. The method of claim 3, wherein said combined loyalty instrument comprises a universal loyalty instrument assigned to said patron, wherein said universal loyalty instrument is adapted to facilitate the storage of loyalty credits awarded to said patron from participation in gaming activities involving the placement of a wager, the play of a game, and the possibility of a monetary award based upon the outcome of the game, and wherein said universal loyalty instrument is also adapted to facilitate the storage of loyalty credits awarded to said patron from purchases involving the procurement of food, lodging, entertainment, transportation, merchandise or services.

5. The method of claim 1, wherein said loyalty credits comprise player tracking points.

6. The method of claim 1, wherein said combined loyalty instrument comprises said first loyalty instrument adjusted to reflect the addition of said second amount of loyalty credits.

7. The method of claim 1, wherein said combined loyalty instrument is separate from said first loyalty instrument.

8. The method of claim 7, wherein at least one of said combined loyalty instrument and said first loyalty instrument is assigned to and redeemed from said patron for a one time only use.

9. The method of claim 1, wherein said gaming establishment is a casino.

10. The method of claim 1, wherein said gaming establishment is a gaming entity comprising a plurality of venues.

11. The method of claim 1, wherein said gaming activity comprises playing a gaming machine of said gaming establishment.

12. The method of claim 1, wherein said first amount of loyalty credits or said second amount of loyalty credits are awarded to said patron without receiving personal identification information from the patron.

13. The method of claim 1, wherein said patron has a player tracking account with said gaming establishment, and wherein said first amount of loyalty credits or said second amount of loyalty credits are awarded to said patron anonymously, without crediting said player tracking account of the patron.

14. The method of claim 1, further including the step of:
establishing a theoretical all expenditures profile for said patron based upon at least said purchase made by said patron and said gaming activity involving the placement of a wager by said patron.

15. The method of claim 1, further including the step of:
awarding a customized comp to said patron based upon at least said purchase made by said patron and said gaming activity involving the placement of a wager by said patron, said customized comp being awarded on the initiative of said gaming establishment and without any specific request from said patron for said comp.

16. The method of claim 15, wherein said step of awarding a customized comp does not affect any amount of loyalty credits assigned or belonging to said patron.

17. A method of awarding comps to patrons of a gaming establishment, the method comprising:
determining that a patron of said gaming establishment has begun a gaming activity involving the placement of a wager by said patron, the play of a game, and the possibility of a monetary award to said patron based upon the outcome of said game;
tracking the amount of participation of said patron in said gaming activity;
assigning to said patron a first level of consideration corresponding to the amount of participation of said patron in said gaming activity;
determining that said patron has made a purchase involving the procurement of food, lodging, entertainment, transportation, merchandise or services;
tracking the amount of money spent by said patron on said purchase;
assigning to said patron a second level of consideration corresponding to the amount of money spent by said patron on said purchase, said second level of consideration being independent of said first level of consideration; and
awarding a customized comp to said patron based upon at least said first level of consideration and said second level of consideration, said customized comp being awarded on the initiative of said gaming establishment and without any specific request from said patron for said comp.

18. The method of claim 17, wherein said gaming establishment is a casino.

19. The method of claim 17, wherein said gaming establishment is a gaming entity comprising a plurality of venues.

20. The method of claim 17, wherein said gaming activity comprises playing a gaming machine of said gaming establishment.

21. The method of claim 17, further including the step of:
establishing a theoretical all expenditures profile for said patron based upon at least said purchase made by said patron and said gaming activity involving the placement of a wager by said patron.

22. The method of claim 17, further including the steps of:
awarding said patron a first amount of loyalty credits corresponding to the participation of said patron in said gaming activity; and
awarding said patron a second amount of loyalty credits corresponding to said purchase.

23. The method of claim 22, wherein said second amount of loyalty credits are in the same units as said first amount of loyalty credits.

24. The method of claim 22, wherein said first amount of loyalty credits or said second amount of loyalty credits are awarded to said patron without receiving personal identification information from the patron.

25. The method of claim 22, wherein said patron has a player tracking account with said gaming establishment, and wherein said first amount of loyalty credits or said second amount of loyalty credits are awarded to said patron anonymously, without crediting said player tracking account of the patron.

26. The method of claim 22, further including the step of:
providing a loyalty instrument, said loyalty instrument being adapted to facilitate the tracking of an amount of loyalty credits attributable to said patron.

27. The method of claim 26, wherein said loyalty instrument is selected from the group consisting of a smart card, a debit card, a magnetic striped card, a printed ticket, a room key and a portable wireless device.

28. The method of claim 27, wherein said loyalty instrument comprises a universal loyalty instrument assigned to said patron, wherein said universal loyalty instrument is adapted to facilitate the storage of loyalty credits awarded to said patron from participation in gaming activities involving the placement of a wager, the play of a game, and the possibility of a monetary award based upon the outcome of the game, and wherein said universal loyalty instrument is also adapted to facilitate the storage of loyalty credits awarded to said patron from purchases involving the procurement of food, lodging, entertainment, transportation, merchandise or services.

29. A method of differentiating patrons of a gaming establishment, comprising:
tracking the gaming activities of a first patron, wherein said gaming activities include one or more instances involving the placement of a wager, the play of a game, and the possible grant of a monetary award based upon the outcome of said game;
tracking the purchasing activities of said first patron, wherein said purchasing activities include one or more instances involving the procurement of food, lodging, entertainment, transportation, merchandise or services;
establishing a first theoretical all expenditures profile for said first patron based upon at least said gaming activities tracked for said first patron and said purchasing activities tracked for said first patron;
tracking the gaming activities of a second patron, wherein said gaming activities include one or more instances involving the placement of a wager, the play of a game, and the possible grant of a monetary award based upon the outcome of said game;
tracking the purchasing activities of said second patron, wherein said purchasing activities include one or more instances involving the procurement of food, lodging, entertainment, transportation, merchandise or services; and
establishing a second theoretical all expenditures profile for said second patron based upon at least said gaming activities tracked for said second patron and said purchasing activities tracked for said second patron.

30. The method of claim 29, wherein said first theoretical all expenditures profile for said first patron reflects an expected value of said first patron to said gaming establishment based upon substantially all expenditures of said first patron within or about said gaming establishment over a given time interval.

31. The method of claim 30, wherein all expenditures of said first patron associated with said gaming establishment includes substantially all gaming activities of said first patron within or about said gaming establishment and substantially all purchasing activities of said first patron, including all instances involving the procurement of food, lodging, entertainment, transportation, merchandise and services by said first patron within or about said gaming establishment.

32. The method of claim 29, wherein said gaming establishment is a casino.

33. The method of claim 29, wherein said gaming establishment is a gaming entity comprising a plurality of venues.

34. The method of claim 29, wherein said gaming activities of said first patron comprise playing a gaming machine of said gaming establishment.

35. The method of claim 29, further including the steps of:
awarding said first patron a first amount of loyalty credits corresponding to said tracked gaming activities of said first patron; and
awarding said first patron a second amount of loyalty credits corresponding to said tracked purchasing activities of said first patron.

36. The method of claim 35, wherein said second amount of loyalty credits are in the same units as said first amount of loyalty credits.

37. The method of claim 35, wherein said first amount of loyalty credits or said second amount of loyalty credits are awarded to said first patron without receiving personal identification information from said first patron.

38. The method of claim 35, wherein said first patron has a player tracking account with said gaming establishment, and wherein said first amount of loyalty credits or said second amount of loyalty credits are awarded to said first patron anonymously, without crediting said player tracking account of said first patron.

39. The method of claim 35, further including the step of:
providing a first loyalty instrument to said first patron, said first loyalty instrument being adapted to facilitate the tracking of an amount of loyalty credits attributable to said first patron.

40. The method of claim 39, wherein said first loyalty instrument is selected from the group consisting of a smart card, a debit card, a magnetic striped card, a printed ticket, a room key and a portable wireless device.

41. The method of claim 40, wherein said first loyalty instrument comprises a universal loyalty instrument assigned to said first patron, wherein said universal loyalty instrument is adapted to facilitate the storage of loyalty credits awarded to said first patron from participation in gaming activities involving the placement of a wager, the play of a game, and the possibility of a monetary award based upon the outcome of the game, and wherein said universal loyalty instrument is also adapted to facilitate the storage of loyalty credits awarded to said first patron from purchases involving the procurement of food, lodging, entertainment, transportation, merchandise or services.

42. The method of claim 35, further including the steps of:
awarding said second patron a third amount of loyalty credits corresponding to said tracked gaming activities of said second patron; and
awarding said second patron a fourth amount of loyalty credits corresponding to said tracked purchasing activities of said second patron.

43. The method of claim 29, further including the step of:
awarding a customized comp to said first patron based upon at least a portion of said tracked gaming activities of said first patron and at least a portion of said tracked purchasing activities of said first patron, said customized comp being awarded on the initiative of said gaming establishment and without any specific request from said first patron for said comp.

44. The method of claim 43, wherein said step of awarding a customized comp to said first patron does not affect any amount of loyalty credits assigned or belonging to said first patron.

45. The method of claim 29, wherein substantially all expenditures of said first and second patrons within or about said gaming establishment are tracked.

46. A loyalty credit system adapted for tracking, differentiating and awarding loyalty credits to patrons of a gaming establishment providing a loyalty credits program, comprising:
one or more loyalty credit generation gaming sites configured to generate and issue primary amounts of loyalty credits to patrons based upon the gaming activities of said patrons, said gaming activities involving the placement of wagers, the play of games, and the possibility of monetary awards based upon the outcome of said games;
one or more loyalty credit generation purchasing sites configured to generate and issue secondary amounts of loyalty credits to patrons based upon the purchasing activities of said patrons, said purchasing activities involving the procurement of food, lodging, entertainment, transportation, merchandise or services, wherein said secondary amounts of loyalty credits are in the same units as said primary amounts of loyalty credits;
a plurality of loyalty instruments adapted to facilitate the tracking and commingling of at least a portion of said primary amounts of loyalty credits and at least a portion of said secondary amounts of loyalty credits; and
one or more loyalty program servers configured to store loyalty credit system information, to establish theoretical all expenditures profiles for said patrons based upon at least said gaming activities and said purchasing activities of said patrons, and to make recommendations to gaming establishment personnel regarding awards of customized comps to said patrons based upon said theoretical all expenditures profiles, said customized comps being awarded on the initiative of said gaming establishment and without any specific request from said patrons for said comps.
